(19) United States
(12) Patent Application Publication
(10) Pub. No.: US 2024/0272368 A1
(43) Pub. Date: Aug. 15, 2024

(54) DENSE PHOTONIC INTEGRATED CIRCUIT OPTICAL COUPLING

(71) Applicant: Intel Corporation, Santa Clara, CA (US)

(72) Inventors: Richard Laming, Santa Clara, CA (US); Nicholas D. Psaila, Lanark (GB)

(73) Assignee: Intel Corporation, Santa Clara, CA (US)

(21) Appl. No.: 18/565,376

(22) PCT Filed: Dec. 2, 2022
(86) PCT No.: PCT/GB2022/053074

§ 371 Date: Nov. 29, 2023

(30) Foreign Application Priority Data
Dec. 3, 2021 (GB) 2117494.1

(51) Int. Cl. G02B 6/32; G02B 6/26

(52) U.S. Cl. CPC G02B 6/32; G02B 6/262

(57) ABSTRACT

An optical interconnect arrangement for use in transmitting light between a photonic integrated circuit and a plurality of optical fibres, comprises a plurality of primary optical beam management elements, a plurality of secondary optical beam management elements, and a plurality of optical fibre alignment structures. Each optical fibre alignment structure is configured to receive a corresponding optical fibre so that the end of the corresponding optical fibre is aligned with, but separated from, a corresponding one of the secondary optical beam management elements, and the optical interconnect arrangement defines a plurality of optical paths, each optical path extending from a surface of the optical interconnect arrangement to the end of a corresponding one of the optical fibre alignment structures via a corresponding one of the primary optical beam management elements and a corresponding one of the secondary optical beam management elements. An optical system is also disclosed which comprises the optical interconnect arrangement, a photonic integrated circuit, and a plurality of optical fibres.

### FIELD

The present disclosure relates to components and assemblies for assisting in high density optical coupling to and/or from photonic integrated circuits (PICs) such as Silicon Photonic (SiPh) devices.

### BACKGROUND

A significant requirement exists for high channel count optical input/output (I/O) ports in silicon photonic integrated circuit (PIC) applications. This is compounded by the need for tight integration between electronics and photonics in Co-packaged Optics applications (CPO), where transitioning from electronic I/O to photonic I/O can offer significant advantages and high bandwidth scalability.

Achieving high channel counts using conventional optical fiber attach processes can use an undesirable amount of space on the silicon chip which has significant cost and practicality implications.

Conventional optical fiber arrays can achieve channel pitches of the order of the 100 μm, limited by the diameter of the optical fibers used in such arrays. Common pitches are 250 μm or 127 μm, however smaller pitches are also available by using smaller diameter optical fibers such as those with an 80 μm diameter. However using one dimensional arrays of such optical fibers in conventional V-groove arrays places significant limitations on the channel densities achievable.

Optical I/O couplers on PICs can be manufactured with significantly smaller pitch between adjacent couplers such as 25 μm, and can therefore offer substantial increases in channel density. However optical interposer devices are then required to provide optical coupling between these structures and the optical fibers used to carry the signals to the receivers.

Edge-coupled optical interposer devices are commonly used on silicon photonic platforms to provide broad spectral bandwidth and low loss coupling to silicon photonic waveguides. However due to the edge geometry, known edge-coupled optical interposer devices are limited to 1D arrays such that reducing the channel-to-channel pitch is the only route available to increase I/O density.

Alternatively, optical interposer devices may be used which employ grating couplers to vertically couple light in and out of silicon photonics platforms. Grating couplers may allow for 2D arrays of couplers to provide more efficient use of die real-estate for I/O. However, the alignment of known optical interposer devices which employ grating couplers with silicon photonics platforms may be complex and/or may require a high degree of precision.

### SUMMARY

It should be understood that any one or more of the features of any one of the following aspects of the present disclosure may be combined with any one or more of the features of any of the other foregoing aspects of the present disclosure.

According to an aspect of the present disclosure there is provided an optical interconnect arrangement for use in transmitting light between a photonic integrated circuit and a plurality of optical fibres, the optical interconnect arrangement comprising:
a plurality of primary optical beam management elements, each primary optical beam management element configured to collimate light received from a corresponding optical element of the photonic integrated circuit or to focus light onto a corresponding optical element of the photonic integrated circuit;
a plurality of secondary optical beam management elements, each secondary optical beam management element configured to focus light onto an end of a corresponding one of the optical fibres or to collimate light received from an end of a corresponding one of the optical fibres; and
a plurality of optical fibre alignment structures,
wherein each optical fibre alignment structure is configured to receive a corresponding optical fibre so that the end of the corresponding optical fibre is aligned with, but separated from, a corresponding one of the secondary optical beam management elements, and
wherein the optical interconnect arrangement defines a plurality of optical paths, each optical path extending from a surface of the optical interconnect arrangement to the end of a corresponding one of the optical fibre alignment structures via a corresponding one of the primary optical beam management elements and a corresponding one of the secondary optical beam management elements.

Optionally, one or more of the of the primary optical beam management elements comprise an optical beam collimating element or an optical beam focusing element.

Optionally, one or more of the of the secondary optical beam management elements comprise an optical beam collimating element or an optical beam focusing element.

Optionally, one or more of the primary optical beam management elements comprises a microlens.

Optionally, one or more of the secondary optical beam management elements comprises a microlens.

Optionally, one or more of the primary optical beam management elements comprise a waveguide structure such as a segmented waveguide, or a tapered waveguide.

Optionally, one or more of the secondary optical beam management elements comprise a waveguide structure such as a segmented waveguide, or a tapered waveguide.

Optionally, one or more of the primary optical beam management elements comprise a graded index (GRIN) lens such as a GRIN lens made by the laser modification of the refractive index of a monolithic block of material such as glass or a GRIN lens made by inserting a GRIN rod into a hole which is laser etched into a monolithic block of material.

Optionally, one or more of the secondary optical beam management elements comprise a graded index (GRIN) lens such as a GRIN lens made by the laser modification of the refractive index of a monolithic block of material such as glass or a GRIN lens made by inserting a GRIN rod into a hole which is laser etched into a monolithic block of material.

Optionally, one or more of the primary optical beam management elements comprises a 2D curved micromirror such as a 2D curved total internally reflecting (TIR) micromirror.

Optionally, one or more of the secondary optical beam management elements comprises a 2D curved micromirror such as a 2D curved total internally reflecting (TIR) micromirror.

Optionally, the primary optical beam management elements are arranged in a 1D array such as a regular 1D array.

Optionally, the primary optical beam management elements have a staggered arrangement. Use of a staggered arrangement of primary optical beam management elements may allow optical coupling with the photonic integrated circuit at a higher density than prior art optical coupling solutions.

Optionally, the primary optical beam management elements are arranged in a 2D array such as a regular 2D array. Use of a 2D array of the primary optical beam management elements may allow optical coupling with the photonic integrated circuit at a higher density than prior art optical coupling solutions.

Optionally, the optical fibre alignment structures are arranged in a 1D array such as a regular 1D array.

Optionally, the optical fibre alignment structures have a staggered arrangement. Use of a staggered arrangement of optical fibre alignment structures may allow optical coupling with the photonic integrated circuit at a higher density than prior art optical coupling solutions.

Optionally, the optical fibre alignment structures are arranged in a 2D array such as a regular 2D array. Use of a 2D array of optical fibre alignment structures may allow optical coupling with the photonic integrated circuit at a higher density than prior art optical coupling solutions.

Optionally, the plurality of primary optical beam management elements and the plurality of secondary optical beam management elements have matching or corresponding spatial arrangements.

Optionally, two or more of the primary optical beam management elements and the corresponding two or more optical fibre alignment structures are arranged in the same plane. Such an optical interconnect arrangement may define two or more optical paths, wherein each optical path extends from, or through, a corresponding primary optical beam management element to a corresponding optical fibre alignment structure, and wherein the two or more optical paths extend in the same plane.

Optionally, adjacent primary optical beam management elements are configured to direct light along parallel optical paths.

Optionally, adjacent primary optical beam management elements are configured to direct light along non-parallel optical paths.

Optionally, alternate primary optical beam management elements are configured to direct light along parallel optical paths.

Optionally, two or more of the primary optical beam management elements and the corresponding two or more optical fibre alignment structures are arranged in different planes. For example, two or more of the primary optical beam management elements may be arranged in a first plane and the corresponding two or more optical fibre alignment structures may be arranged in a second plane which is orthogonal to the first plane. Such an optical interconnect arrangement may define two or more optical paths, wherein each optical path extends from, or through, a corresponding primary optical beam management element to a corresponding optical fibre alignment structure, and wherein the two or more optical paths extend in different planes.

Two or more of the primary optical beam management elements may be arranged in a 1D array such as a regular 1D array extending along a first axis and the corresponding two or more optical fibre alignment structures may be arranged in a 1D array such as a regular 1D array extending along a second axis which is orthogonal to the first axis. Such an optical interconnect arrangement may define two or more optical paths, wherein each optical path extends from, or through, a corresponding primary optical beam management element to a corresponding optical fibre alignment structure, and wherein the two or more optical paths extend in different planes.

Optionally, each optical path changes direction at least once.

Optionally, each optical path changes direction at least once by an angle of 90° or by an angle in the region of 90°, for example by an angle between 60° and 120, by an angle between 85° and 95°, or by an angle between 88° and 92°°.

Optionally, each optical path changes direction at a corresponding one of the primary optical beam management elements.

Optionally, each optical path changes direction at a corresponding one of the secondary optical beam management elements.

Optionally, each primary optical beam management element defines an angle through which the corresponding optical path changes direction.

Optionally, each secondary optical beam management element defines an angle through which the corresponding optical path changes direction.

Optionally, the optical interconnect arrangement comprises a reflector and each optical path changes direction at the reflector.

Optionally, the reflector defines an angle by which each of the optical paths changes direction.

Optionally, the reflector is configured to reflect light travelling between the plurality of primary optical beam management elements and the plurality of secondary optical beam management elements.

The photonic integrated circuit may comprise a plurality of integrated optical waveguides.

Optionally, each optical element of the photonic integrated circuit comprises a surface coupler element for directing light into or out of a corresponding one of the integrated optical waveguides through a surface of the photonic integrated circuit such as a surface above or below the corresponding one of the integrated optical waveguides.

Optionally, each of the primary optical beam management elements is configured to focus light onto a corresponding one of the surface coupler elements of the photonic integrated circuit or to collimate light received from a corresponding one of the surface coupler elements of the photonic integrated circuit. Such an optical interconnect arrangement may simplify the coupling of light between each integrated optical waveguide of a photonic integrated circuit and a corresponding optical fibre of a plurality of optical fibres via the surface of the photonic integrated circuit above or below the plurality of integrated optical waveguides.

Optionally, the surface coupler elements are arranged in a 1D array such as a regular 1D array.

Optionally, the surface coupler elements have a staggered arrangement. Use of a staggered arrangement of surface coupler elements may allow optical coupling with the photonic integrated circuit at a higher density than prior art optical coupling solutions.

Optionally, the surface coupler elements are arranged in a 2D array such as a regular 2D array. Use of a 2D array of surface coupler elements may allow optical coupling with the photonic integrated circuit at a higher density than prior art optical coupling solutions.

Optionally, the photonic integrated circuit comprises a step formed at an edge of the photonic integrated circuit, wherein the step includes a ledge and a facet.

Optionally, each integrated optical waveguide of the photonic integrated circuit ends at the facet of the photonic integrated circuit so as to define a corresponding optical port at the facet of the photonic integrated circuit.

Optionally, each optical element of the photonic integrated circuit comprises a corresponding one of the optical ports.

Optionally, each of the primary optical beam management elements is configured to focus light onto a corresponding one of the optical ports or to collimate light received from a corresponding one of the optical ports.

Optionally, the optical interconnect arrangement comprises a step formed at an edge of the optical interconnect arrangement, the step including a ledge and a facet. In use, the facet may be disposed between the optical ports of the photonic integrated circuit and the plurality of primary optical beam management elements.

Optionally, the step formed at the edge of the optical interconnect arrangement is complementary to the step formed at the edge of the photonic integrated circuit.

Optionally, the plurality of primary optical beam management elements and the ledge of the optical interconnect arrangement are separated by a predetermined distance in one dimension which matches a predetermined distance by which a plurality of optical ports of the photonic integrated circuit and a reference surface of the photonic integrated circuit are separated in the same dimension. Optionally, the step of the optical interconnect arrangement is configured to allow engagement between the ledge of the optical interconnect arrangement and the reference surface of the photonic integrated circuit without the ledge of the photonic integrated circuit engaging the optical interconnect arrangement. Consequently, engagement between the ledge of the optical interconnect arrangement and the reference surface of the photonic integrated circuit results in alignment of the plurality of primary optical beam management elements of the optical interconnect arrangement with the plurality of optical ports of the photonic integrated circuit in one dimension.

Optionally, the optical interconnect arrangement comprises one or more fiducial markers disposed on the ledge of the optical interconnect arrangement, each of the one or more fiducial markers being configured for alignment with one or more corresponding fiducial markers disposed on the reference surface of the photonic integrated circuit for alignment of the optical interconnect arrangement and the photonic integrated circuit.

Optionally, the plurality of primary optical beam management elements of the optical interconnect arrangement and a reference surface of the optical interconnect arrangement are separated by a predetermined distance in one dimension which matches a predetermined distance by which the plurality of optical ports of the photonic integrated circuit and the ledge of the photonic integrated circuit are separated in the same dimension. Optionally, the step of the optical interconnect arrangement is configured to allow engagement between the reference surface of the optical interconnect arrangement and the ledge of the photonic integrated circuit without the ledge of the optical interconnect arrangement engaging the photonic integrated circuit. Consequently, engagement between the reference surface of the optical interconnect arrangement and the ledge of the photonic integrated circuit results in alignment of the plurality of primary optical beam management elements of the optical interconnect arrangement with the optical ports of the photonic integrated circuit in one dimension.

Optionally, the optical interconnect arrangement comprises one or more fiducial markers disposed on the reference surface of the optical interconnect arrangement, each of the one or more fiducial markers being configured for alignment with one or more corresponding fiducial markers disposed on the ledge of the photonic integrated circuit for alignment of the optical interconnect arrangement and the photonic integrated circuit.

Optionally, the facet of the optical interconnect arrangement is formed by etching.

Optionally, the ledge of the optical interconnect arrangement is formed by etching.

Optionally, the facet of the photonic integrated circuit is formed by etching.

Optionally, the ledge of the photonic integrated circuit is formed by etching.

Optionally, any two or more of the plurality of primary optical beam management elements, the reflector, the plurality of secondary optical beam management elements, and the plurality of optical fibre alignment structures are formed integrally in a monolithic block of material such as a monolithic block of glass, for example a monolithic block of fused silica.

Optionally, any two or more of the plurality of primary optical beam management elements, the reflector, the plurality of secondary optical beam management elements, and the plurality of optical fibre alignment structures are formed separately and then brought into engagement and/or attached to one another.

Optionally, the optical interconnect arrangement comprises an optical interconnect component which includes a monolithic block of material such as glass, for example a monolithic block of fused silica, wherein the plurality of primary optical beam management elements, the plurality of secondary optical beam management elements, and the plurality of optical fibre alignment structures are formed integrally in the monolithic block of material.

Optionally, the optical interconnect component comprises one or more alignment features, each alignment feature being formed integrally in the monolithic block of material and each alignment feature being configured to engage a corresponding complementary alignment feature of the photonic integrated circuit for passive alignment of the optical interconnect component and the photonic integrated circuit.

Optionally, the step of the optical interconnect arrangement is formed at an edge of the optical interconnect component. Optionally, the step of the optical interconnect arrangement is formed at an edge of the monolithic block of material of the optical interconnect component.

Optionally, the optical interconnect arrangement comprises:
a primary optical beam management element array component; and
an optical fibre connector ferrule,
wherein the primary optical beam management element array component includes a first monolithic block of material such as glass, for example a first monolithic block of fused silica, the plurality of primary optical beam management elements being formed integrally in the first monolithic block of material, and
wherein the optical fibre connector ferrule includes a second monolithic block of material such as glass, for example a second monolithic block of fused silica, the plurality of secondary optical beam management elements and the plurality of optical fibre alignment structures being formed integrally in the second monolithic block of material.

Optionally, the primary optical beam management element array component is configured to be attached, for example, bonded to the photonic integrated circuit.

Optionally, the optical fibre connector ferrule is configured for alignment with the primary optical beam management element array component so as to align each secondary optical beam management element of the optical fibre connector ferrule with a corresponding primary optical beam management element of the primary optical beam management element array component for the transmission of light between each primary optical beam management element of the primary optical beam management element array component and a corresponding secondary optical beam management element of the optical fibre connector ferrule.

Optionally, the optical fibre connector ferrule and the primary optical beam management element array component are configured to be pluggable or connectable.

Optionally, the optical fibre connector ferrule and the primary optical beam management element array component are configured to be detachably attached.

Optionally, wherein the primary optical beam management element array component and the optical fibre connector ferrule have one or more complementary inter-engaging alignment features for the passive alignment of the primary optical beam management element array component and the optical fibre connector ferrule.

Optionally, the primary optical beam management element array component comprises one or more alignment features for alignment of the primary optical beam management element array component with the optical fibre connector ferrule, each alignment feature of the primary optical beam management element array component being formed integrally in the first monolithic block of material.

Optionally, the optical fibre connector ferrule comprises one or more alignment features for alignment of the optical fibre connector ferrule with the primary optical beam management element array component, each alignment feature of the optical fibre connector ferrule being formed integrally in the second monolithic block of material.

Optionally, the one or more complementary inter-engaging alignment features of the primary optical beam management element array component and the optical fibre connector ferrule comprise one or more alignment pins or projections and one or more complementary alignment holes. One or more of the alignment pins or projections may be formed integrally in the first monolithic block of material or formed integrally in the second monolithic block of material. One or more of the alignment pins or projections may be formed separately from the first monolithic block of material and formed separately from the second monolithic block of material.

Optionally, the optical interconnect arrangement comprises:
a reflective primary optical beam management element array component; and
an optical fibre connector ferrule,
wherein the reflective primary optical beam management element array component includes a first monolithic block of material such as glass, for example a first monolithic block of fused silica, the first monolithic block of material defining the plurality of primary optical beam management elements and a reflector,
wherein each optical path changes direction at the reflector, and
wherein the optical fibre connector ferrule includes a second monolithic block of material such as glass, for example a second monolithic block of fused silica, the plurality of secondary optical beam management elements and the plurality of optical fibre alignment structures being formed integrally in the second monolithic block of material.

Optionally, the reflective primary optical beam management element array component comprises one or more alignment features, each alignment feature being formed integrally in the first monolithic block of material and each alignment feature being configured to engage a corresponding complementary alignment feature of the photonic integrated circuit for passive alignment of the reflective primary optical beam management element array component and the photonic integrated circuit.

Optionally, the optical fibre connector ferrule is configured for engagement with the reflective primary optical beam management element array component so as to align each secondary optical beam management element of the optical fibre connector ferrule with a corresponding primary optical beam management element of the reflective primary optical beam management element array component for the transmission of light between each primary optical beam management element of the reflective primary optical beam management element array component and a corresponding secondary optical beam management element of the optical fibre connector ferrule via the reflector.

Optionally, the optical fibre connector ferrule and the reflective primary optical beam management element array component are configured to be pluggable or connectable.

Optionally, the optical fibre connector ferrule and the reflective primary optical beam management element array component are configured to be detachably attached.

Optionally, the reflective primary optical beam management element array component and the optical fibre connector ferrule have one or more complementary inter-engaging alignment features for the passive alignment of the reflective primary optical beam management element array component and the optical fibre connector ferrule.

Optionally, the reflective primary optical beam management element array component comprises one or more alignment features for alignment of the reflective primary optical beam management element array component with the optical fibre connector ferrule, each alignment feature of the reflective primary optical beam management element array component being formed integrally in the first monolithic block of material.

Optionally, the optical fibre connector ferrule comprises one or more alignment features for alignment of the optical fibre connector ferrule with the reflective primary optical beam management element array component, each alignment feature of the optical fibre connector ferrule being formed integrally in the second monolithic block of material.

Optionally, the one or more complementary inter-engaging alignment features of the reflective primary optical beam management element array component and the optical fibre connector ferrule comprise one or more alignment pins or projections and one or more complementary alignment holes. One or more of the alignment pins or projections may be formed integrally in the first monolithic block of material or formed integrally in the second monolithic block of material. One or more of the alignment pins or projections may be formed separately from the first monolithic block of material and formed separately from the second monolithic block of material.

Optionally, the step of the optical interconnect arrangement is formed at an edge of the reflective primary optical beam management element array component. Optionally, the step of the optical interconnect arrangement is formed at an edge of the first monolithic block of material of the reflective primary optical beam management element array component.

Optionally, the optical interconnect arrangement comprises:
a primary optical beam management element array component;
a reflector component defining a reflector, wherein each optical path changes direction at the reflector; and
an optical fibre connector ferrule,
wherein the primary optical beam management element array component includes a first monolithic block of material such as glass, for example a first monolithic block of fused silica, the plurality of primary optical beam management elements being formed integrally in the first monolithic block of material,
wherein the optical fibre connector ferrule includes a second monolithic block of material such as glass, for example a second monolithic block of fused silica, the plurality of secondary optical beam management elements and the plurality of optical fibre alignment structures being formed integrally in the second monolithic block of material, and
wherein the reflector component includes a third monolithic block of material such as glass, for example a first monolithic block of fused silica, the reflector being formed integrally in the third monolithic block of material.

Optionally, the primary optical beam management element array component is configured for engagement with the reflector component and the optical fibre connector ferrule is configured for engagement with the reflector component so as to align each secondary optical beam management element of the optical fibre connector ferrule with a corresponding primary optical beam management element of the primary optical beam management element array component for the transmission of light between each primary optical beam management element of the primary optical beam management element array component and a corresponding secondary optical beam management element of the optical fibre connector ferrule via the reflector of the reflector component.

Optionally, the reflector component and the primary optical beam management element array component are configured to be pluggable or connectable.

Optionally, the reflector component and the primary optical beam management element array component are configured to be detachably attached.

Optionally, the optical fibre connector ferrule and the reflector component are configured to be pluggable or connectable.

Optionally, the optical fibre connector ferrule and the reflector component are configured to be detachably attached.

Optionally, the primary optical beam management element array component and the reflector component have one or more complementary inter-engaging alignment features for the passive alignment of the primary optical beam management element array component and the reflector component.

Optionally, the primary optical beam management element array component comprises one or more alignment features for alignment of the primary optical beam management element array component with the reflector component, each alignment feature of the primary optical beam management element array component being formed integrally in the first monolithic block of material.

Optionally, the reflector component comprises one or more alignment features for alignment of the reflector component with the primary optical beam management element array component, each alignment feature of the reflector component being formed integrally in the third monolithic block of material.

Optionally, the one or more complementary inter-engaging alignment features of the primary optical beam management element array component and the reflector component comprise one or more alignment pins or projections and one or more complementary alignment holes. One or more of the alignment pins or projections may be formed integrally in the first monolithic block of material or formed integrally in the third monolithic block of material. One or more of the alignment pins or projections may be formed separately from the first monolithic block of material and formed separately from the third monolithic block of material.

Optionally, the secondary optical beam management element array component and the reflector component have one or more complementary inter-engaging alignment features for the passive alignment of the secondary optical beam management element array component and the reflector component.

Optionally, the secondary optical beam management element array component comprises one or more alignment features for alignment of the secondary optical beam management element array component with the reflector component, each alignment feature of the secondary optical beam management element array component being formed integrally in the second monolithic block of material.

Optionally, the reflector component comprises one or more alignment features for alignment of the reflector component with the secondary optical beam management element array component, each alignment feature of the reflector component being formed integrally in the third monolithic block of material.

Optionally, the one or more complementary inter-engaging alignment features of the secondary optical beam management element array component and the reflector component comprise one or more alignment pins or projections and one or more complementary alignment holes. One or more of the alignment pins or projections may be formed integrally in the second monolithic block of material or formed integrally in the third monolithic block of material. One or more of the alignment pins or projections may be formed separately from the second monolithic block of material and formed separately from the third monolithic block of material.

Optionally, each optical fibre comprises a plurality of optical fibre cores and wherein each optical fibre alignment structure is configured to engage a corresponding optical fibre so that an end of each optical fibre core of the corresponding optical fibre is aligned with, but separated from, a corresponding one of the secondary optical beam management elements.

Optionally, formation of any of one or more of the plurality of primary optical beam management elements, the reflector, the plurality of secondary optical beam management elements, and the plurality of optical fibre alignment structures comprises using a laser such as an ultrafast laser or a femtosecond laser to inscribe one or more monolithic blocks of material in one or more regions so as to modify the material of each monolithic block in the one or more regions.

Optionally, formation of any of one or more of the plurality of primary optical beam management elements, the reflector, the plurality of secondary optical beam management elements, and the plurality of optical fibre alignment structures comprises using a laser such as an ultrafast laser or a femtosecond laser to inscribe one or more monolithic blocks of material in one or more regions so as to modify a refractive index of the material of each monolithic block in the one or more regions.

Optionally, formation of any of one or more of the plurality of primary optical beam management elements, the reflector, the plurality of secondary optical beam management elements, and the plurality of optical fibre alignment structures comprises using the laser to inscribe one or more monolithic blocks of material in one or more regions so as to modify a chemical etchability of the material of each monolithic block in the one or more regions and subsequently removing the modified material of each monolithic block from the one or more regions, for example by chemical etching.

Optionally, formation of any of one or more of the plurality of primary optical beam management elements, the reflector, the plurality of secondary optical beam management elements, and the plurality of optical fibre alignment structures comprises using the laser to inscribe one or more monolithic blocks of material in one or more regions so as to ablate the material of each monolithic block in the one or more regions.

Optionally, each monolithic block of material comprises a monolithic block of glass such as a monolithic block of fused silica.

According to an aspect of the present disclosure there is provided an optical system comprising the optical interconnect arrangement as described above, a photonic integrated circuit, and a plurality of optical fibres, wherein the photonic integrated circuit and the optical interconnect arrangement are attached, for example bonded, and wherein each optical fibre is attached, for example bonded, to a corresponding optical fibre alignment structure of the optical interconnect arrangement.

Optionally, the photonic integrated circuit comprises a plurality of integrated optical waveguides.

Optionally, each optical element of the photonic integrated circuit comprises a surface coupler element for directing light into or out of a corresponding one of the integrated optical waveguides through a surface of the photonic integrated circuit such as a surface above or below the corresponding one of the integrated optical waveguides.

Optionally, each of the primary optical beam management elements is configured to focus light onto a corresponding one of the surface coupler elements of the photonic integrated circuit or to collimate light received from a corresponding one of the surface coupler elements of the photonic integrated circuit. Such an optical interconnect arrangement may simplify the coupling of light between each integrated optical waveguide of a photonic integrated circuit and a corresponding optical fibre of a plurality of optical fibres via the surface of the photonic integrated circuit above or below the plurality of integrated optical waveguides.

Optionally, the surface coupler elements are arranged in a 1D array such as a regular 1D array.

Optionally, the surface coupler elements have a staggered arrangement. Use of a staggered arrangement of surface coupler elements may allow optical coupling with the photonic integrated circuit at a higher density than prior art optical coupling solutions.

Optionally, the surface coupler elements are arranged in a 2D array such as a regular 2D array. Use of a 2D array of surface coupler elements may allow optical coupling with the photonic integrated circuit at a higher density than prior art optical coupling solutions.

Optionally, each surface coupler element of the photonic integrated circuit comprises a grating coupler element.

Optionally, each surface coupler element of the photonic integrated circuit comprises a 2D curved micromirror such as a 2D curved TIR micromirror.

Optionally, the plurality of optical fibres comprises a 1D array of optical fibres such as a regular 1D array of optical fibres. The regular 1D array of optical fibres may have a pitch of 80 μm or greater.

Optionally, the plurality of optical fibres comprises a staggered arrangement of optical fibres. Use of a staggered arrangement of optical fibres may allow optical coupling with the photonic integrated circuit at a higher density than prior art optical coupling solutions.

Optionally, the plurality of optical fibres comprises a 2D array of optical fibres such as a regular 2D array of optical fibres. Use of a 2D array of optical fibres may allow optical coupling with the photonic integrated circuit at a higher density than prior art optical coupling solutions.

Optionally, the photonic integrated circuit comprises a step formed at an edge of the photonic integrated circuit, wherein the step includes a ledge and a facet.

Optionally, each integrated optical waveguide of the photonic integrated circuit ends at the facet of the photonic integrated circuit so as to define a corresponding optical port at the facet of the photonic integrated circuit.

Optionally, each optical element of the photonic integrated circuit comprises a corresponding one of the optical ports.

Optionally, each of the primary optical beam management elements is configured to focus light onto a corresponding one of the optical ports or to collimate light received from a corresponding one of the optical ports.

Optionally, the optical interconnect arrangement comprises a step formed at an edge of the optical interconnect arrangement, the step including a ledge and a facet.

Optionally, the facet is disposed between the optical ports of the photonic integrated circuit and the plurality of primary optical beam management elements.

Optionally, the step formed at the edge of the optical interconnect arrangement is complementary to the step formed at the edge of the photonic integrated circuit.

Optionally, the plurality of primary optical beam management elements and the ledge of the optical interconnect arrangement are separated by a predetermined distance in one dimension which matches a predetermined distance by which a plurality of optical ports of the photonic integrated circuit and a reference surface of the photonic integrated circuit are separated in the same dimension. Optionally, the ledge of the optical interconnect arrangement and the reference surface of the photonic integrated circuit are in engagement, whilst the ledge of the photonic integrated circuit and the optical interconnect arrangement are out of engagement. Consequently, engagement between the ledge of the optical interconnect arrangement and the reference surface of the photonic integrated circuit results in alignment of the plurality of primary optical beam management elements of the optical interconnect arrangement with the plurality of optical ports of the photonic integrated circuit in one dimension.

Optionally, the optical interconnect arrangement comprises one or more fiducial markers disposed on the ledge of the optical interconnect arrangement, each of the one or more fiducial markers being configured for alignment with one or more corresponding fiducial markers disposed on the reference surface of the photonic integrated circuit for alignment of the optical interconnect arrangement and the photonic integrated circuit.

Optionally, the plurality of primary optical beam management elements of the optical interconnect arrangement and a reference surface of the optical interconnect arrangement are separated by a predetermined distance in one dimension which matches a predetermined distance by which the plurality of optical ports of the photonic integrated circuit and the ledge of the photonic integrated circuit are separated in the same dimension. Optionally, the reference surface of the optical interconnect arrangement and the ledge of the photonic integrated circuit are in engagement, whilst the ledge of the optical interconnect arrangement and the photonic integrated circuit are out of engagement. Consequently, engagement between the reference surface of the optical interconnect arrangement and the ledge of the photonic integrated circuit results in alignment of the plurality of primary optical beam management elements of the optical interconnect arrangement with the optical ports of the photonic integrated circuit in one dimension.

Optionally, the optical interconnect arrangement comprises one or more fiducial markers disposed on the reference surface of the optical interconnect arrangement, each of the one or more fiducial markers being configured for alignment with one or more corresponding fiducial markers disposed on the ledge of the photonic integrated circuit for alignment of the optical interconnect arrangement and the photonic integrated circuit.

Optionally, the facet of the optical interconnect arrangement is formed by etching.

Optionally, the ledge of the optical interconnect arrangement is formed by etching.

Optionally, the facet of the photonic integrated circuit is formed by etching.

Optionally, the ledge of the photonic integrated circuit is formed by etching.

Optionally, the photonic integrated circuit comprises or is formed from silicon, for example wherein the photonic integrated circuit is a silicon photonic integrated circuit.

Optionally, each optical fibre comprises a plurality of optical fibre cores and wherein each optical fibre alignment structure is configured to engage a corresponding optical fibre so that an end of each optical fibre core of the corresponding optical fibre is aligned with, but separated from, a corresponding one of the secondary optical beam management elements.

### BRIEF DESCRIPTION OF THE DRAWINGS

Optical interconnect arrangements and optical systems will now be described by way of non-limiting example only with reference to the accompanying drawings of which:

FIG. 1A is a schematic side view of a first optical interconnect arrangement in use transmitting light between a photonic integrated circuit and a plurality of optical fibres attached to the first optical interconnect arrangement:

FIG. 1B is a schematic side view of the first optical interconnect arrangement of FIG. 1A;

FIG. 2 is a schematic side view of a second optical interconnect arrangement in use transmitting light between a photonic integrated circuit and a plurality of optical fibres attached to the second optical interconnect arrangement;

FIG. 3 is a schematic side view of a third optical interconnect arrangement in use transmitting light between a photonic integrated circuit and a plurality of optical fibres attached to the third optical interconnect arrangement;

FIG. 4 is a schematic side view of a fourth optical interconnect arrangement in use transmitting light between a photonic integrated circuit and a plurality of optical fibres attached to the fourth optical interconnect arrangement;

FIG. 5 is a schematic side view of a fifth optical interconnect arrangement in use transmitting light between a photonic integrated circuit and a plurality of optical fibres attached to the fifth optical interconnect arrangement;

FIG. 6 is a schematic side view of a sixth optical interconnect arrangement in use transmitting light between a photonic integrated circuit and a plurality of optical fibres attached to the sixth optical interconnect arrangement; and

FIG. 7 is a schematic plan view of an optical fibre connector ferrule.

### DETAILED DESCRIPTION OF THE DRAWINGS

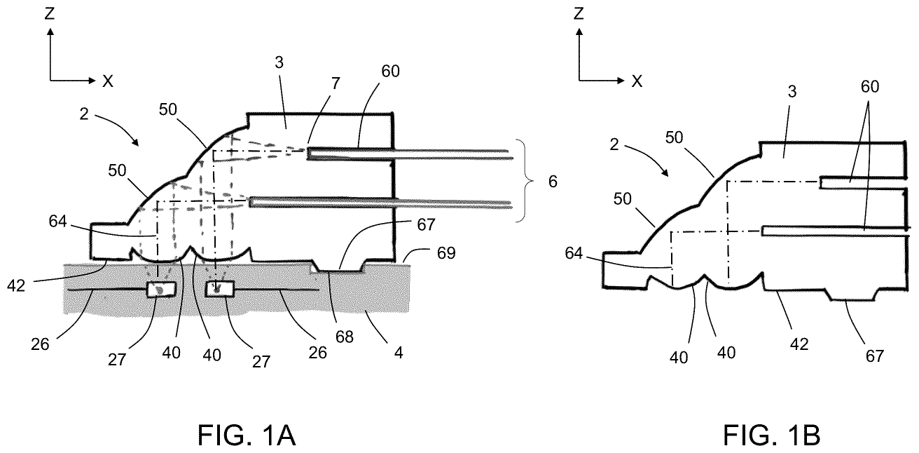

Referring initially to FIG. 1A there is shown a schematic side view of a first optical interconnect arrangement in the form or an optical interconnect component generally designated 2 for transmitting light between a photonic integrated circuit such as a silicon photonic integrated circuit 4 and a plurality of optical fibres 6. As will be described in more detail below, the optical interconnect component 2 is attached to the photonic integrated circuit 4 and the plurality of optical fibres 6 are attached to the optical interconnect component 2.

As shown FIG. 1A, the photonic integrated circuit 4 includes a plurality of integrated optical waveguides 26 and a plurality of optical elements in the form of a plurality of grating coupler elements 27 arranged in a staggered arrangement or a uniform 2D array. Each integrated optical waveguide 26 of the photonic integrated circuit 4 ends at a corresponding one of the grating coupler elements 27. Each grating coupler element 27 is configured to couple light vertically upwardly out of the corresponding integrated optical waveguide 26 through an upper surface 69 of the photonic integrated circuit 4 into the optical interconnect arrangement 2 or to couple light vertically downwardly from the optical interconnect arrangement 2 into the corresponding integrated optical waveguide 26 through the upper surface 69 of the photonic integrated circuit 4.

As shown FIGS. 1A and 1B, the optical interconnect component 2 is formed in a monolithic block of material such as a monolithic block of fused silica 3. The optical interconnect component 2 includes a plurality of primary optical beam management elements in the form of a plurality of microlenses 40 formed in an underside 42 of the monolithic block of fused silica 3 and arranged in a staggered arrangement or a uniform 2D array having a spatial arrangement which matches a spatial arrangement of the grating coupler elements 27 of the photonic integrated circuit 4. Although not shown explicitly in FIG. 1A or 1B, the monolithic block of fused silica 3 may define one or more epoxy dam or recess structures in the underside 42 of the monolithic block of fused silica 3, wherein epoxy dam or recess structures are configured to avoid the flow of adhesive or epoxy onto the microlenses 40 during attachment of the optical interconnect component 2 to the photonic integrated circuit 4.

The optical interconnect component 2 further includes a plurality of secondary optical beam management elements in the form of a plurality of 2D curved TIR micromirrors 50 formed on a sloping surface of the monolithic block of fused silica 3 and arranged in a staggered arrangement or a uniform 2D array having a spatial arrangement which matches a spatial arrangement of the plurality of microlenses 40.

The optical interconnect component 2 further includes a plurality of optical fibre alignment structures in the form of a plurality of optical fibre alignment holes 60 formed integrally in the monolithic block of fused silica 3, wherein each optical fibre alignment hole 60 is configured for engagement with a corresponding optical fibre 6 so that an end 7 of the corresponding optical fibre 6 is aligned with, but separated from, a corresponding one of the 2D curved TIR micromirrors 50. Moreover, although not shown in FIG. 1A or 1B, the optical interconnect component 2 includes one or more passages or channels extending between a surface of the optical interconnect arrangement 2 and each optical fibre alignment hole 60 to assist with the flow of an adhesive fluid such as epoxy for the attachment of each optical fibre 6 in the corresponding optical fibre alignment hole 60.

The optical interconnect component 2 defines a plurality of optical paths 64, each optical path 64 extending from the underside 42 of the monolithic block of fused silica 3 to an end 7 of one of the optical fibre alignment holes 60 via a corresponding one of the microlenses 40 and a corresponding one of the 2D curved TIR micromirrors 50. As may be appreciated from FIG. 1A, each optical path 64 changes direction at the corresponding 2D curved TIR micromirror 50 by an angle of 90° or an angle in the region of 90°.

The optical interconnect component 2 also includes one or more alignment features in the form of one or more protrusions or projections 67 formed integrally on the underside 42 of the monolithic block of fused silica 3, wherein each protrusion or projection 67 is configured to engage a corresponding complementary alignment feature in the form of a corresponding recess 68 formed in an upper surface 69 of the photonic integrated circuit 4 for passive alignment of the optical interconnect component 2 and the photonic integrated circuit 4.

Specifically, the one or more recesses 68 of the photonic integrated circuit 4 are positioned relative to the grating coupler elements 27 of the photonic integrated circuit 4, and the one or more protrusions or projections 67 are positioned relative to the microlenses 40 of the optical interconnect component 2 to ensure that the grating coupler elements 27 of the photonic integrated circuit 4 and the microlenses 40 of the optical interconnect component 2 are passively aligned when the one or more protrusions or projections 67 of the optical interconnect component 2 are inserted into the one or more recesses 68 of the photonic integrated circuit 4.

In use, when the one or more protrusions or projections 67 of the optical interconnect component 2 are inserted into the one or more recesses 68 of the photonic integrated circuit 4, light is transmitted between the integrated optical waveguides 26 of the photonic integrated circuit 4 and the optical fibres 6 via the optical interconnect component 2. As may be appreciated from FIG. 1A, reflection of light from each 2D curved TIR micromirror 50 redirects the light through an angle of 90° or through an angle in the region of 90°.

From the foregoing description, it will be understood that the optical interconnect component 2 serves to optically couple the plurality of integrated optical waveguides 26 of the photonic integrated circuit 4 and the uniform 2D array of optical fibres 6 in a way that is simpler than prior art optical interconnect arrangements thereby enabling high density photonic integrated circuit optical I/O to be achieved more readily compared with prior art optical interconnect arrangements.

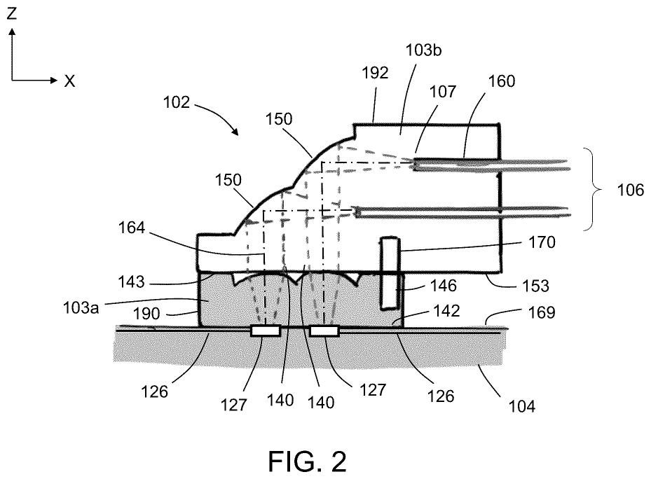

Referring to FIG. 2 there is shown a schematic side view of a second optical interconnect arrangement generally designated 102 for transmitting light between a photonic integrated circuit such as a silicon photonic integrated circuit 104 and a plurality of optical fibres 106. The optical interconnect arrangement 102 comprises a primary optical beam management element array component 190 and a separately formed optical fibre connector ferrule 192. As will be described in more detail below, the primary optical beam management element array component 190 is attached to the photonic integrated circuit 104 and the plurality of optical fibres 106 are attached to the optical fibre connector ferrule 192.

As shown FIG. 2, the photonic integrated circuit 104 includes a plurality of integrated optical waveguides 126 and a plurality of optical elements in the form of a plurality of grating coupler elements 127 arranged in a staggered arrangement or a uniform 2D array. Each integrated optical waveguide 126 of the photonic integrated circuit 104 ends at a corresponding one of the grating coupler elements 127. Each grating coupler element 127 is configured to couple light vertically upwardly out of the corresponding integrated optical waveguide 126 through an upper surface 169 of the photonic integrated circuit 104 into the primary optical beam management element array component 190 or to couple light vertically downwardly from the primary optical beam management element array component 190 through the upper surface 169 of the photonic integrated circuit 104 into the corresponding integrated optical waveguide 126.

The primary optical beam management element array component 190 includes a first monolithic block of material such as a first monolithic block of fused silica 103a and a plurality of primary optical beam management elements in the form of a plurality of microlenses 140 formed integrally in an upper surface 143 of the first monolithic block of fused silica 103a. The plurality of microlenses 140 are arranged in a staggered arrangement or a uniform 2D array having a spatial arrangement which matches a spatial arrangement of the grating coupler elements 127 of the photonic integrated circuit 104.

The primary optical beam management element array component 190 also includes one or more alignment features in the form of one or more alignment holes 146 formed integrally in the first monolithic block of fused silica 103a for use in aligning the primary optical beam management element array component 190 and the optical fibre connector ferrule 192.

The optical fibre connector ferrule 192 includes a second monolithic block of material such as a second monolithic block of fused silica 103b and a plurality of secondary optical beam management elements in the form of a plurality of 2D curved TIR micromirrors 150 formed integrally on a sloping surface of the second monolithic block of fused silica 103b. The plurality of 2D curved TIR micromirrors 150 are arranged in a staggered arrangement or a uniform 2D array having a spatial arrangement which matches a spatial arrangement of the plurality of microlenses 140.

The optical fibre connector ferrule 192 further includes a plurality of optical fibre alignment structures in the form of a plurality of optical fibre alignment holes 160 formed integrally in the second monolithic block of fused silica 103b, wherein each optical fibre alignment hole 160 is configured for engagement with a corresponding optical fibre 106 so that an end 107 of the corresponding optical fibre 106 is aligned with, but separated from, a corresponding one of the 2D curved TIR micromirrors 150. Moreover, although not shown in FIG. 2, the optical fibre connector ferrule 192 includes one or more passages or channels extending between a surface of the optical fibre connector ferrule 192 and each optical fibre alignment hole 160 to assist with the flow of an adhesive fluid such as epoxy for the attachment of each optical fibre 106 in the corresponding optical fibre alignment hole 160.

The optical fibre connector ferrule 192 further includes one or more pins 170, wherein each pin 170 is configured to be received in a corresponding one of the holes 146 of the primary optical beam management element array component 190 for the passive alignment of the primary optical beam management element array component 190 and the optical fibre connector ferrule 192. Specifically, the alignment holes 146 of the primary optical beam management element array component 190 are positioned relative to the microlenses 140 of the primary optical beam management element array component 190, and the pins 170 of the optical fibre connector ferrule 192 are positioned relative to the 2D curved TIR micromirrors 150 of the optical fibre connector ferrule 192 to ensure that the microlenses 140 of the primary optical beam management element array component 190 and the 2D curved TIR micromirrors 150 of the optical fibre connector ferrule 192 are passively aligned when the pins 170 of the optical fibre connector ferrule 192 are inserted into the alignment holes 146 of the primary optical beam management element array component 190. The pins 170 may be formed integrally in the second monolithic block of fused silica 103b. Alternatively, the second monolithic block of fused silica 103b may define a plurality of holes, each hole configured to receive a corresponding one of the pins 170.

The primary optical beam management element array component 190 is aligned relative to the photonic integrated circuit 104 so as to align each of the microlenses 140 of the primary optical beam management element array component 190 with a corresponding grating coupler element 127 of the photonic integrated circuit 104 in the X and Y directions and an underside 142 of the primary optical beam management element array component 190 is attached, for example bonded, to an upper surface 169 of the photonic integrated circuit 104.

Each optical fibre 106 of the plurality of optical fibres is attached, for example bonded, into a corresponding one of the optical fibre alignment holes 160 so that an end 107 of the corresponding optical fibre 106 is aligned with, but separated from, a corresponding one of the 2D curved TIR micromirrors 150.

The one or more pins 170 of the optical fibre connector ferrule 192 are then inserted into the one or more alignment holes 146 of the primary optical beam management element array component 190 so as to passively align the microlenses 140 of the primary optical beam management element array component 190 and the microlenses 150 of the optical fibre connector ferrule 192.

The optical interconnect arrangement 102 then defines a plurality of optical paths 164, each optical path 164 extending from the underside 142 of the primary optical beam management element array component 190 to an end 107 of one of the optical fibre alignment holes 160 via a corresponding one of the microlenses 140 and a corresponding one of the 2D curved TIR micromirrors 150. As may be appreciated from FIG. 2, each optical path 164 changes direction at the corresponding 2D curved TIR micromirror 150 by an angle of 90° or an angle in the region of 90°.

In use, light is then transmitted between the integrated optical waveguides 126 of the photonic integrated circuit 104 and the optical fibres 106 via the primary optical beam management element array component 190 and the optical fibre connector ferrule 192. As may be appreciated from FIG. 2, reflection of light from each 2D curved TIR micromirror 150 redirects the light through an angle of 90° or through an angle in the region of 90°.

From the foregoing description, it will be understood that the optical interconnect arrangement 102 serves to optically couple the plurality of integrated optical waveguides 126 of the photonic integrated circuit 104 and the staggered arrangement or uniform 2D array of optical fibres 106 in a way that is simpler than prior art optical interconnect arrangements thereby enabling high density photonic integrated circuit optical I/O to be achieved more readily compared with prior art optical interconnect arrangements. Furthermore, as a result of the one or more pins 170 of the optical fibre connector ferrule 192 and the one or more alignment holes 146 of the primary optical beam management element array component 190, one of ordinary skill in the art will understand that the optical fibre connector ferrule 192 and the primary optical beam management element array component 190 are configured to be pluggable or connectable. The primary optical beam management element array component 190 and the optical fibre connector ferrule 192 may also include one or more mechanical features (not shown) such as one or more arms, clips or clamps for detachably attaching the primary optical beam management element array component 190 and the optical fibre connector ferrule 192, for example for connecting, latching or holding the primary optical beam management element array component 190 and the optical fibre connector ferrule 192 together.

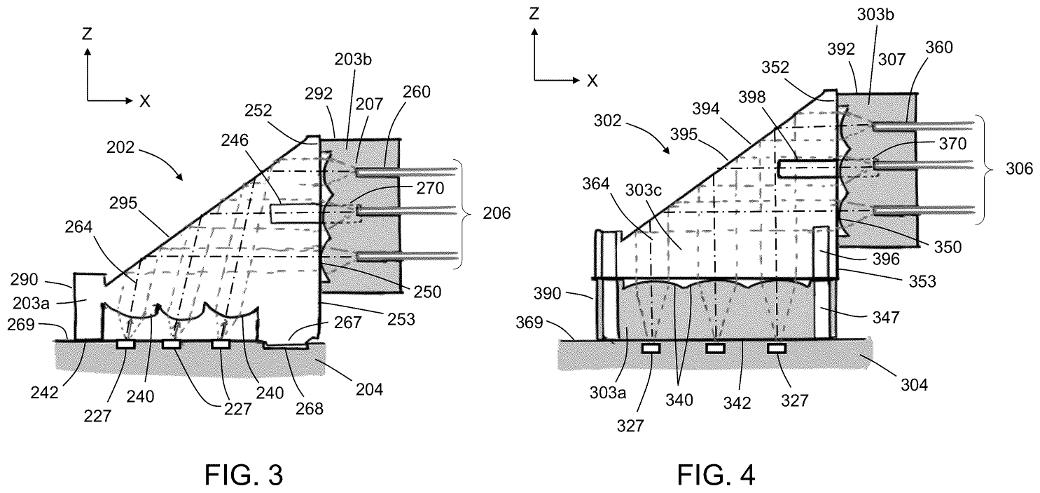

Referring to FIG. 3 there is shown a schematic side view of a third optical interconnect arrangement generally designated 202 for transmitting light between a photonic integrated circuit such as a silicon photonic integrated circuit 204 and a plurality of optical fibres 206. The optical interconnect arrangement 202 comprises a primary optical beam management element array component 290 and a separately formed optical fibre connector ferrule 292. As will be described in more detail below, the primary optical beam management element array component 290 is attached to the photonic integrated circuit 204 and the plurality of optical fibres 206 are attached to the optical fibre connector ferrule 292.

As shown in FIG. 3, the photonic integrated circuit 204 includes a plurality of optical elements in the form of a plurality of grating coupler elements 227 arranged in a staggered arrangement or a uniform 2D array. Although not shown in FIG. 3, it should be understood that the photonic integrated circuit 204 also includes a plurality of integrated optical waveguides, wherein each integrated optical waveguide ends at a corresponding one of the grating coupler elements 227. Each grating coupler element 227 is configured to couple light out of the corresponding integrated optical waveguide upwardly through an upper surface 269 of the photonic integrated circuit 204 into the primary optical beam management element array component 290 along a direction which defines an acute angle relative to the vertical direction, or each grating coupler element 227 is configured to couple light downwardly from the primary optical beam management element array component 290 through the upper surface 269 of the photonic integrated circuit 204 into the corresponding integrated optical waveguide along a direction which defines an acute angle relative to the vertical direction. The photonic integrated circuit 204 further includes one or more recesses 268 formed in an upper surface 269 thereof for the passive alignment of the primary optical beam management element array component 290 with the photonic integrated circuit 204.

The primary optical beam management element array component 290 includes a first monolithic block of material such as a first monolithic block of fused silica 203a and a plurality of primary optical beam management elements in the form of a plurality of primary microlenses 240 formed integrally in an underside 242 of the first monolithic block of fused silica 203a. The plurality of primary microlenses 240 are arranged in a staggered arrangement or a uniform 2D array having a spatial arrangement which matches a spatial arrangement of the grating coupler elements 227 of the photonic integrated circuit 204.

The primary optical beam management element array component 290 also includes a reflector in the form of a reflective surface 295 of the first monolithic block of fused silica 203a which slopes at an acute angle, such as an acute angle in the region of 45°, relative to the horizontal.

The primary optical beam management element array component 290 further includes one or more alignment features in the form of one or more protrusions or projections 267, wherein each protrusion or projection 267 is formed integrally in the first monolithic block of material 203a and each protrusion or projection 267 is configured to engage a corresponding one of the recesses 268 of the photonic integrated circuit 204 for passive alignment of the primary optical beam management element array 290 component and the photonic integrated circuit 204.

The primary optical beam management element array component 290 also includes one or more alignment features in the form of one or more alignment holes 246 formed integrally in the first monolithic block of fused silica 203a for use in aligning the primary optical beam management element array component 290 and the optical fibre connector ferrule 292.

The optical fibre connector ferrule 292 includes a second monolithic block of material such as a second monolithic block of fused silica 203b and a plurality of secondary optical beam management elements in the form of a plurality of secondary microlenses 250 formed integrally on a surface 252 of the second monolithic block of fused silica 203b. The secondary microlenses 250 are arranged in a staggered arrangement or a uniform 2D array having a spatial arrangement which matches a spatial arrangement of the plurality of primary microlenses 240.

The optical fibre connector ferrule 292 further includes a plurality of optical fibre alignment structures in the form of a plurality of optical fibre alignment holes 260 formed integrally in the second monolithic block of fused silica 203b, wherein each optical fibre alignment hole 260 is configured for engagement with a corresponding optical fibre 206 so that an end 207 of the corresponding optical fibre 206 is aligned with, but separated from, a corresponding one of the secondary microlenses 250. Moreover, although not shown in FIG. 3, the optical fibre connector ferrule 292 includes one or more passages or channels extending between a surface of the optical fibre connector ferrule 292 and each optical fibre alignment hole 260 to assist with the flow of an adhesive fluid such as epoxy for the attachment of each optical fibre 206 in the corresponding optical fibre alignment hole 260.

The optical fibre connector ferrule 292 further includes one or more pins 270, wherein each pin 270 is configured to be received in a corresponding one of the holes 246 of the primary optical beam management element array component 290 for the passive alignment of the primary optical beam management element array component 290 and the optical fibre connector ferrule 292. Specifically, the alignment holes 246 of the primary optical beam management element array component 290 are positioned relative to the primary microlenses 240 of the primary optical beam management element array component 290, and the pins 270 of the optical fibre connector ferrule 292 are positioned relative to the secondary microlenses 250 of the optical fibre connector ferrule 292 to ensure that the primary microlenses 240 of the primary optical beam management element array component 290 and the secondary microlenses 250 of the optical fibre connector ferrule 292 are passively aligned when the pins 270 of the optical fibre connector ferrule 292 are inserted into the alignment holes 246 of the primary optical beam management element array component 290. The pins 270 may be formed integrally in the second monolithic block of fused silica 203b. Alternatively, the second monolithic block of fused silica 203b may define a plurality of holes, each hole configured to receive a corresponding one of the pins 270.

Each protrusion or projection 267 of the primary optical beam management element array 290 component is brought into engagement with a corresponding one of the recesses 268 of the photonic integrated circuit 204 for passive alignment of the primary optical beam management element array 290 component and the photonic integrated circuit 204 so as to align each of the primary microlenses 240 of the primary optical beam management element array component 290 with a corresponding grating coupler element 227 of the photonic integrated circuit 204 in the X and Y directions, and the underside 242 of the primary optical beam management element array component 290 is attached, for example bonded, to the upper surface 269 of the photonic integrated circuit 204.

Each optical fibre 206 of the plurality of optical fibres is attached, for example bonded, into a corresponding one of the optical fibre alignment holes 260 so that an end 207 of the corresponding optical fibre 206 is aligned with, but separated from, a corresponding one of the secondary microlenses 250.

The one or more pins 270 of the optical fibre connector ferrule 292 are then inserted into the one or more alignment holes 246 of the primary optical beam management element array component 290 and the surface 252 of the optical fibre connector ferrule 292 is brought into engagement with a surface 253 of the primary optical beam management element array component 290 so as to passively align the primary microlenses 240 of the primary optical beam management element array component 290 and the secondary microlenses 250 of the optical fibre connector ferrule 292.

The optical interconnect arrangement 202 then defines a plurality of optical paths 264, each optical path 264 extending from the underside 242 of the primary optical beam management element array component 290 to an end 207 of one of the optical fibre alignment holes 260 via a corresponding one of the primary microlenses 240 and a corresponding one of the secondary microlenses 250. As may be appreciated from FIG. 3, each optical path 264 changes direction at the reflective surface 295 of the first monolithic block of fused silica 203a by an angle of greater than 90°.

In use, light is then transmitted between the integrated optical waveguides 226 of the photonic integrated circuit 204 and the optical fibres 206 via the primary optical beam management element array component 290 and the optical fibre connector ferrule 292. As may be appreciated from FIG. 3, reflection of light from the reflective surface 295 of the first monolithic block of fused silica 203a redirects the light through an angle of greater than 90°, for example approximately 120°. The use of the primary microlenses 240 and the secondary microlenses 250 serve to form a staggered arrangement or a 2D array of expanded collimated optical beams which are transmitted horizontally between the primary optical beam management element array component 290 and the optical fibre connector ferrule 292 thereby relaxing the alignment tolerance required between the primary optical beam management element array component 290 and the optical fibre connector ferrule 292 for a given optical coupling efficiency.

From the foregoing description, it will be understood that the optical interconnect arrangement 202 serves to optically couple the plurality of integrated optical waveguides 226 of the photonic integrated circuit 204 and the staggered arrangement or uniform 2D array of optical fibres 206 in a way that is simpler than prior art optical interconnect arrangements thereby enabling high density photonic integrated circuit optical I/O to be achieved more readily compared with prior art optical interconnect arrangements. Furthermore, as a result of the one or more pins 270 of the optical fibre connector ferrule 292 and the one or more alignment holes 246 of the primary optical beam management element array component 290, one of ordinary skill in the art will understand that the optical fibre connector ferrule 292 and the primary optical beam management element array component 290 are configured to be pluggable or connectable. The primary optical beam management element array component 290 and the optical fibre connector ferrule 292 may also include one or more mechanical features (not shown) such as one or more arms, clips or clamps for detachably attaching the primary optical beam management element array component 290 and the optical fibre connector ferrule 292, for example for connecting, latching or holding the primary optical beam management element array component 290 and the optical fibre connector ferrule 292 together.

Referring to FIG. 4 there is shown a schematic side view of a fourth optical interconnect arrangement generally designated 302 for transmitting light between a photonic integrated circuit such as a silicon photonic integrated circuit 304 and a plurality of optical fibres 306. The optical interconnect arrangement 302 comprises a primary optical beam management element array component 390, a separately formed optical fibre connector ferrule 392, and a separately formed reflector component 394. As will be described in more detail below, the primary optical beam management element array component 390 is attached to the photonic integrated circuit 304 and the plurality of optical fibres 306 are attached to the optical fibre connector ferrule 392.

As shown in FIG. 4, the photonic integrated circuit 304 includes a plurality of optical elements in the form of a plurality of grating coupler elements 327 arranged in a staggered arrangement or a uniform 2D array. Although not shown in FIG. 4, it should be understood that the photonic integrated circuit 304 also includes a plurality of integrated optical waveguides, wherein each integrated optical waveguide ends at a corresponding one of the grating coupler elements 327. Each grating coupler element 327 is configured to couple light vertically upwardly out of the corresponding integrated optical waveguide through an upper surface 369 of the photonic integrated circuit 304 into the primary optical beam management element array component 390 or to couple light vertically downwardly from the primary optical beam management element array component 390 through the upper surface 369 of the photonic integrated circuit 304 into the corresponding integrated optical waveguide of the photonic integrated circuit 304.

The primary optical beam management element array component 390 includes a first monolithic block of material such as a first monolithic block of fused silica 303a and a plurality of primary optical beam management elements in the form of a plurality of primary microlenses 340 formed integrally in an upper surface of the first monolithic block of fused silica 303a. The plurality of primary microlenses 340 are arranged in a staggered arrangement or a uniform 2D array having a spatial arrangement which matches a spatial arrangement of the grating coupler elements 327 of the photonic integrated circuit 304.

The primary optical beam management element array component 390 also includes alignment features in the form of one or more alignment pins 347 for use in aligning the primary optical beam management element array component 390 and the reflector component 394. The one or more alignment pins 347 may be formed integrally in the first monolithic block of fused silica 303a. Alternatively, the first monolithic block of fused silica 303a may define a plurality of holes, each hole configured to receive a corresponding one of the alignment pins 347.

The optical fibre connector ferrule 392 includes a second monolithic block of material such as a second monolithic block of fused silica 303b and a plurality of secondary optical beam management elements in the form of a plurality of secondary microlenses 350 formed integrally on a surface 352 of the second monolithic block of fused silica 303b. The secondary microlenses 350 are arranged in a staggered arrangement or a uniform 2D array having a spatial arrangement which matches a spatial arrangement of the plurality of primary microlenses 340.

The optical fibre connector ferrule 392 further includes a plurality of optical fibre alignment structures in the form of a plurality of optical fibre alignment holes 360 formed integrally in the second monolithic block of fused silica 303b, wherein each optical fibre alignment hole 360 is configured for engagement with a corresponding optical fibre 306 so that an end 307 of the corresponding optical fibre 306 is aligned with, but separated from, a corresponding one of the secondary microlenses 350. Moreover, although not shown in FIG. 4, the optical fibre connector ferrule 392 includes one or more passages or channels extending between a surface of the optical fibre connector ferrule 392 and each optical fibre alignment hole 360 to assist with the flow of an adhesive fluid such as epoxy for the attachment of each optical fibre 306 in the corresponding optical fibre alignment hole 360.

The optical fibre connector ferrule 392 further includes alignment pins 370, for use in aligning the optical fibre connector ferrule 392 and the reflector component 394. The one or more alignment pins 370 may be formed integrally in the second monolithic block of fused silica 303b. Alternatively, the second monolithic block of fused silica 303b may define a plurality of holes, each hole configured to receive a corresponding one of the alignment pins 370.

The reflector component 394 includes a third monolithic block of material such as a third monolithic block of fused silica 303c and a reflector in the form of a reflective surface 395 of the third monolithic block of fused silica 303c, wherein the reflective surface 395 slopes at an angle in the region of 45° to the horizontal. The reflector component 394 further includes alignment holes 396 formed integrally in the third monolithic block of fused silica 303c for use in receiving the alignment pins 347 of the primary optical beam management element array component 390 for the passive alignment of the reflector component 394 with the primary optical beam management element array component 390. Similarly, the reflector component 394 further includes alignment holes 398 formed integrally in the third monolithic block of fused silica 303c for use in receiving the alignment pins 370 of the optical fibre connector ferrule 392 for the passive alignment of the reflector component 394 with the optical fibre connector ferrule 392.

The primary optical beam management element array 390 component is aligned relative to the photonic integrated circuit 304 so as to align each of the primary microlenses 340 of the primary optical beam management element array component 390 with a corresponding grating coupler element 327 of the photonic integrated circuit 304 in the X and Y directions, and the underside 342 of the primary optical beam management element array component 390 is attached, for example bonded, to the upper surface 369 of the photonic integrated circuit 304.

Each optical fibre 306 of the plurality of optical fibres is attached, for example bonded, into a corresponding one of the optical fibre alignment holes 360 so that an end 307 of the corresponding optical fibre 306 is aligned with, but separated from, a corresponding one of the secondary microlenses 350.

The alignment pins 347 of the primary optical beam management element array component 390 are positioned relative to the primary microlenses 340 of the primary optical beam management element array component 390, the alignment holes 396 and 398 of the reflector component 394 are positioned relative to the reflective surface 395 of the reflector component 394, and the alignment pins 370 of the optical fibre connector ferrule 392 are positioned relative to the secondary microlenses 350 of the optical fibre connector ferrule 392 to ensure that the primary microlenses 340 of the primary optical beam management element array component 390 and the secondary microlenses 350 of the optical fibre connector ferrule 392 are passively aligned when the alignment pins 347 of the primary optical beam management element array component 390 are inserted into the alignment holes 396 of the reflector component 394 and the alignment pins 370 of the optical fibre connector ferrule 392 are inserted into the alignment holes 398 of the reflector component 394. The upper surface of the primary optical beam management element array component 390 and the lower surface of the reflector component 394 are brought into engagement. Similarly, the surface 352 of the optical fibre connector ferrule 392 is brought into engagement with a surface 353 of the reflector component 394.

The optical interconnect arrangement 302 then defines a plurality of optical paths 364, each optical path 364 extending from the underside 342 of the primary optical beam management element array component 390 to an end 307 of one of the optical fibre alignment holes 360 via a corresponding one of the primary microlenses 340 and a corresponding one of the secondary microlenses 350. As may be appreciated from FIG. 4, each optical path 364 changes direction at the reflective surface 395 of the reflector component 394 by an angle of 90° or an angle in the region of 90°.

In use, light is then transmitted between the integrated optical waveguides of the photonic integrated circuit 304 and the optical fibres 306 via the primary optical beam management element array component 390, the reflector component 394, and the optical fibre connector ferrule 392. As may be appreciated from FIG. 4, reflection of light from the reflective surface 395 of the reflector component 394 redirects the light through an angle of 90° or through an angle in the region of 90°. The use of the primary microlenses 340 and the secondary microlenses 350 serve to form a staggered arrangement or a 2D array of expanded collimated optical beams which are transmitted between the primary optical beam management element array component 390 and the optical fibre connector ferrule 392 thereby relaxing the alignment tolerance required between the primary optical beam management element array component 390 and the optical fibre connector ferrule 392 for a given optical coupling efficiency.

From the foregoing description, it will be understood that the optical interconnect arrangement 302 serves to optically couple the plurality of integrated optical waveguides of the photonic integrated circuit 304 and the staggered arrangement or uniform 2D array of optical fibres 306 in a way that is simpler than prior art optical interconnect arrangements thereby enabling high density photonic integrated circuit optical I/O to be achieved more readily compared with prior art optical interconnect arrangements. Furthermore, as a result of the pins 347 of the primary optical beam management element array component 390, the pins 370 of the optical fibre connector ferrule 392 and the alignment holes 396, 398 of the reflector component 394, one of ordinary skill in the art will understand that the optical fibre connector ferrule 392, the reflector component 394 and the primary optical beam management element array component 390 are configured to be pluggable or connectable. The primary optical beam management element array component 390, the reflector component 394, and the optical fibre connector ferrule 392 may also include one or more mechanical features (not shown) such as one or more arms, clips or clamps for detachably attaching the primary optical beam management element array component 390, the reflector component 394 and the optical fibre connector ferrule 392, for example for connecting, latching or holding the primary optical beam management element array component 390, the reflector component 394 and the optical fibre connector ferrule 392 together.

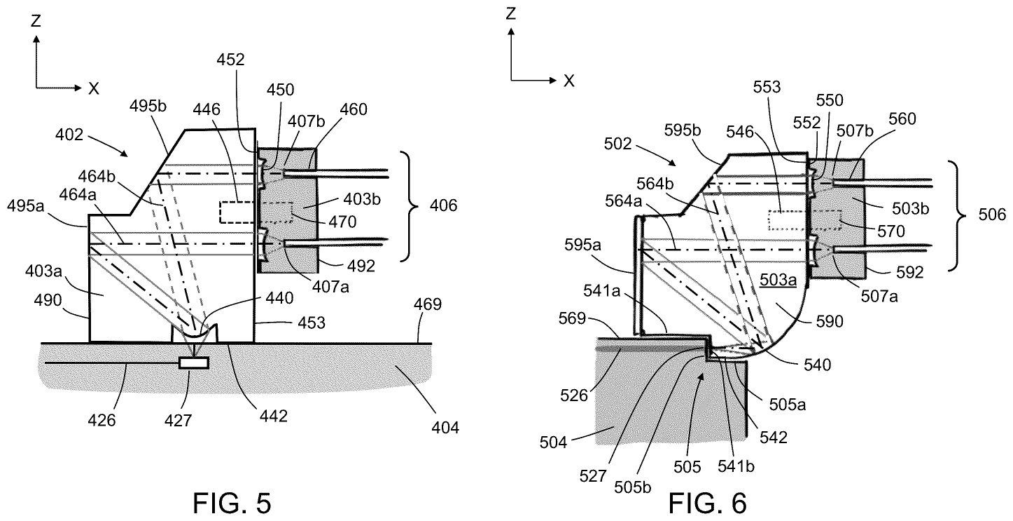

Referring to FIG. 5 there is shown a schematic side view of a fifth optical interconnect arrangement generally designated 402 for transmitting light between a photonic integrated circuit such as a silicon photonic integrated circuit 404 and a plurality of optical fibres 406. The optical interconnect arrangement 402 comprises a primary optical beam management element array component 490 and a separately formed optical fibre connector ferrule 492. As will be described in more detail below, the primary optical beam management element array component 490 is attached to the photonic integrated circuit 404 and the plurality of optical fibres 406 are attached to the optical fibre connector ferrule 492.

As shown in FIG. 5, the photonic integrated circuit 404 includes a plurality of optical elements in the form of a plurality of grating coupler elements 427 arranged in a uniform 1D array along a direction parallel to the Y direction. The photonic integrated circuit 404 also includes a plurality of integrated optical waveguides 426, wherein each integrated optical waveguide 426 ends at a corresponding one of the grating coupler elements 427. Each grating coupler element 427 is configured to couple light out of the corresponding integrated optical waveguide 426 upwardly through an upper surface 469 of the photonic integrated circuit 404 into the primary optical beam management element array component 490 along a direction which defines an acute angle relative to the vertical direction, or each grating coupler element 427 is configured to couple light downwardly from the primary optical beam management element array component 490 through the upper surface 469 of the photonic integrated circuit 404 into the corresponding integrated optical waveguide 426 along a direction which defines an acute angle relative to the vertical direction.

The primary optical beam management element array component 490 includes a first monolithic block of material such as a first monolithic block of fused silica 403a and a plurality of primary optical beam management elements in the form of a plurality of primary microlenses 440 formed integrally in an underside 442 of the first monolithic block of fused silica 403a. The plurality of primary microlenses 440 are arranged in a uniform 1D array having a spatial arrangement which matches a spatial arrangement of the grating coupler elements 427 of the photonic integrated circuit 404.

The primary optical beam management element array component 490 also includes reflectors in the form of a first planar reflective surface 495a of the first monolithic block of fused silica 403a and a second planar reflective surface 495b of the first monolithic block of fused silica 403a.

The primary optical beam management element array component 490 also includes one or more alignment features in the form of one or more alignment holes 446 formed integrally in the first monolithic block of fused silica 403a for use in aligning the primary optical beam management element array component 490 and the optical fibre connector ferrule 492.

The optical fibre connector ferrule 492 includes a second monolithic block of material such as a second monolithic block of fused silica 403b and a plurality of secondary optical beam management elements in the form of a plurality of secondary microlenses 450 formed integrally on a surface 452 of the second monolithic block of fused silica 403b. The secondary microlenses 450 are arranged in a uniform 2D array.

The optical fibre connector ferrule 492 further includes a plurality of optical fibre alignment structures in the form of a plurality of optical fibre alignment holes 460 formed integrally in the second monolithic block of fused silica 403b, wherein each optical fibre alignment hole 460 is configured for engagement with a corresponding optical fibre 406 so that an end 407 of the corresponding optical fibre 406 is aligned with, but separated from, a corresponding one of the secondary microlenses 450. Moreover, although not shown in FIG. 5, the optical fibre connector ferrule 492 includes one or more passages or channels extending between a surface of the optical fibre connector ferrule 492 and each optical fibre alignment hole 460 to assist with the flow of an adhesive fluid such as epoxy for the attachment of each optical fibre 406 in the corresponding optical fibre alignment hole 460.

The optical fibre connector ferrule 492 further includes one or more pins 470, wherein each pin 470 is configured to be received in a corresponding one of the holes 446 of the primary optical beam management element array component 490 for the passive alignment of the primary optical beam management element array component 490 and the optical fibre connector ferrule 492. Specifically, the alignment holes 446 of the primary optical beam management element array component 490 are positioned relative to the primary microlenses 440 of the primary optical beam management element array component 490, and the pins 470 of the optical fibre connector ferrule 492 are positioned relative to the secondary microlenses 450 of the optical fibre connector ferrule 492 to ensure that the primary microlenses 440 of the primary optical beam management element array component 490 and the secondary microlenses 450 of the optical fibre connector ferrule 492 are passively aligned when the pins 470 of the optical fibre connector ferrule 492 are inserted into the alignment holes 446 of the primary optical beam management element array component 490. The pins 470 may be formed integrally in the second monolithic block of fused silica 403b. Alternatively, the second monolithic block of fused silica 403b may define a plurality of holes, each hole configured to receive a corresponding one of the pins 470.

Each of the primary microlenses 440 of the primary optical beam management element array component 490 is aligned with a corresponding grating coupler element 427 of the photonic integrated circuit 404 in the X and Y directions, and the underside 442 of the primary optical beam management element array component 490 is attached, for example bonded, to the upper surface 469 of the photonic integrated circuit 404.

Each optical fibre 406 of the plurality of optical fibres is attached, for example bonded, into a corresponding one of the optical fibre alignment holes 460 so that an end 407 of the corresponding optical fibre 406 is aligned with, but separated from, a corresponding one of the secondary microlenses 450.

The one or more pins 470 of the optical fibre connector ferrule 492 are then inserted into the one or more alignment holes 446 of the primary optical beam management element array component 490 and the surface 452 of the optical fibre connector ferrule 492 is brought into engagement with a surface 453 of the primary optical beam management element array component 490 so as to passively align the primary microlenses 440 of the primary optical beam management element array component 490 and the secondary microlenses 450 of the optical fibre connector ferrule 492.

It should be understood that adjacent primary microlenses 440 are configured differently so as to direct light along non-parallel optical paths 464a, 464b, but that alternate primary microlenses 440 are configured the same so as to direct light along parallel optical paths. Each optical path 464a extends in a plane parallel to the X-Z plane from the underside 442 of the primary optical beam management element array component 490 to an end 407a of one of the optical fibre alignment holes 460 via a corresponding one of the primary microlenses 440, the first reflective surface 495a and a corresponding one of the secondary microlenses 450. In contrast, each optical path 464b extends from the underside 442 of the primary optical beam management element array component 490 to an end 407b of one of the optical fibre alignment holes 460 via a corresponding one of the primary microlenses 440, the second reflective surface 495b and a corresponding one of the secondary microlenses 450, wherein the ends 407a, 407b of the optical fibre alignment holes 460 are aligned in a plane parallel to the X-Z plane. As may be appreciated from FIG. 5, each optical path 464a changes direction at the first reflective surface 495a of the first monolithic block of fused silica 403a and each optical path 464b changes direction at the second reflective surface 495b of the first monolithic block of fused silica 403a. Moreover, as a consequence of the configurations of the primary microlenses 440, light may be coupled between the 1D array of grating coupler elements 427 arranged along a direction parallel to the Y direction and the 2D array of optical fibres 406.

As may be appreciated from FIG. 5, the use of the primary microlenses 440 and the secondary microlenses 450 serve to form a 2D array of expanded collimated optical beams which are transmitted horizontally between the primary optical beam management element array component 490 and the optical fibre connector ferrule 492 thereby relaxing the alignment tolerance required between the primary optical beam management element array component 490 and the optical fibre connector ferrule 492 for a given optical coupling efficiency.

Each of the primary microlenses 440 may be defined independently of each of the other primary microlenses 440. This may allow each of the primary microlenses 440 to have a slightly different configuration, for example to be different in position (offset) relative to the corresponding optical path 464a, 464b or to have a different angle, curvature etc. Similarly, each of the secondary microlenses 450 may be defined independently of each of the other secondary microlenses 450. This may allow each of the secondary microlenses 450 to have a slightly different configuration, for example to be different in position (offset) relative to the corresponding optical path 464a, 464b or to have a different angle, curvature etc. Specifically, the configurations of the primary microlenses 440 and the secondary microlenses 450 may be selected to form a 2D array of collimated beams between the primary optical beam management element array component 490 and the optical fibre connector ferrule 492 with the same or similar beam diameters and orientations.

From the foregoing description, it will be understood that the optical interconnect arrangement 402 may serve to optically couple the 1D array of integrated optical waveguides 426 of the photonic integrated circuit 404 and the 2D array of optical fibres 406 in a way that is simpler than prior art optical interconnect arrangements thereby enabling high density photonic integrated circuit optical I/O to be achieved more readily compared with prior art optical interconnect arrangements. Furthermore, as a result of the one or more pins 470 of the optical fibre connector ferrule 492 and the one or more alignment holes 446 of the primary optical beam management element array component 490, one of ordinary skill in the art will understand that the optical fibre connector ferrule 492 and the primary optical beam management element array component 490 are configured to be pluggable or connectable. The primary optical beam management element array component 490 and the optical fibre connector ferrule 492 may also include one or more mechanical features (not shown) such as one or more arms, clips or clamps for detachably attaching the primary optical beam management element array component 490 and the optical fibre connector ferrule 492, for example for connecting, latching or holding the primary optical beam management element array component 490 and the optical fibre connector ferrule 492 together.

Referring to FIG. 6 there is shown a schematic side view of a sixth optical interconnect arrangement generally designated 502 for transmitting light between a photonic integrated circuit such as a silicon photonic integrated circuit 504 and a plurality of optical fibres 506. The optical interconnect arrangement 502 comprises a primary optical beam management element array component 590 and a separately formed optical fibre connector ferrule 592. As will be described in more detail below, the primary optical beam management element array component 590 is attached to the photonic integrated circuit 504 and the plurality of optical fibres 506 are attached to the optical fibre connector ferrule 592.

As shown in FIG. 6, the photonic integrated circuit 504 includes a step 505 formed at an edge of the photonic integrated circuit 504, wherein the step 505 includes a ledge 505a and a facet 505b. The photonic integrated circuit 504 further includes a plurality of integrated optical waveguides 526, wherein the integrated optical waveguides 526 end at the facet 505b of the photonic integrated circuit 504 thereby defining a plurality of optical elements in the form of a plurality of optical ports 527 arranged in a 1D array along the Y-direction at the facet 505b of the photonic integrated circuit 504. The plurality of optical ports 527 of the photonic integrated circuit 504 are separated from an upper reference surface 569 of the photonic integrated circuit 504 by a predetermined distance. The ledge 505a and/or the facet 505b of the photonic integrated circuit 504 may be formed by etching.

The primary optical beam management element array component 590 includes a first monolithic block of material such as a first monolithic block of fused silica 503a which defines a step formed at an edge of the primary optical beam management element array component 590, the step including a ledge 541a and a facet 541b. The ledge 541a and/or the facet 541b of the primary optical beam management element array component 590 may be formed by etching.

The primary optical beam management element array component 590 includes a plurality of primary optical beam management elements in the form of a plurality of primary 2D curved TIR micromirrors 540 formed integrally in the first monolithic block of fused silica 503a. The plurality of primary 2D curved TIR micromirrors 540 are arranged in a uniform 1D array and have a spatial arrangement which matches a spatial arrangement of the optical ports 527 of the photonic integrated circuit 504.

The plurality of primary 2D curved TIR micromirrors 540 and the ledge 541a of the primary optical beam management element array component 590 are separated in the Z-direction by a predetermined distance which matches the predetermined distance by which the plurality of optical ports 527 of the photonic integrated circuit 504 and the upper reference surface 569 of the photonic integrated circuit 504 are separated in the Z-direction. Moreover, the step of the primary optical beam management element array component 590 is configured to allow engagement between the ledge 541a of the primary optical beam management element array component 590 and the upper reference surface 569 of the photonic integrated circuit 504 without the ledge 505a of the photonic integrated circuit 504 engaging a lower surface 542 of the primary optical beam management element array component 590. Consequently, engagement between the ledge 541a of the primary optical beam management element array component 590 and the upper reference surface 569 of the photonic integrated circuit 504 results in alignment of the plurality of primary 2D curved TIR micromirrors 540 of the primary optical beam management element array component 590 with the ends or optical ports 527 of the photonic integrated circuit 504 in the Z-direction.

Moreover, the primary optical beam management element array component 590 comprises one or more fiducial markers (not shown) disposed on the ledge 541a of the primary optical beam management element array component 590, each of the one or more fiducial markers being configured for alignment with one or more corresponding fiducial markers (not shown) disposed on the upper reference surface 569 of the photonic integrated circuit 504 for alignment of the primary optical beam management element array component 590 and the photonic integrated circuit 504 in X and Y.

The primary optical beam management element array component 590 also includes reflectors in the form of a first planar reflective surface 595a of the first monolithic block of fused silica 503a and a second planar reflective surface 595b of the first monolithic block of fused silica 503a.

The primary optical beam management element array component 590 also includes one or more alignment features in the form of one or more alignment holes 546 formed integrally in the first monolithic block of fused silica 503a for use in aligning the primary optical beam management element array component 590 and the optical fibre connector ferrule 592.

The optical fibre connector ferrule 592 includes a second monolithic block of material such as a second monolithic block of fused silica 503b and a plurality of secondary optical beam management elements in the form of a plurality of secondary microlenses 550 formed integrally on a surface 552 of the second monolithic block of fused silica 503b. The secondary microlenses 550 are arranged in a uniform 2D array.

The optical fibre connector ferrule 592 further includes a plurality of optical fibre alignment structures in the form of a plurality of optical fibre alignment holes 560 formed integrally in the second monolithic block of fused silica 503b, wherein each optical fibre alignment hole 560 is configured for engagement with a corresponding optical fibre 506 so that an end 507 of the corresponding optical fibre 506 is aligned with, but separated from, a corresponding one of the secondary microlenses 550. Moreover, although not shown in FIG. 6, the optical fibre connector ferrule 592 includes one or more passages or channels extending between a surface of the optical fibre connector ferrule 592 and each optical fibre alignment hole 560 to assist with the flow of an adhesive fluid such as epoxy for the attachment of each optical fibre 506 in the corresponding optical fibre alignment hole 560.

The optical fibre connector ferrule 592 further includes one or more pins 570, wherein each pin 570 is configured to be received in a corresponding one of the holes 546 of the primary optical beam management element array component 590 for the passive alignment of the primary optical beam management element array component 590 and the optical fibre connector ferrule 592. Specifically, the alignment holes 546 of the primary optical beam management element array component 590 are positioned relative to the primary 2D curved TIR micromirrors 540 of the primary optical beam management element array component 590, and the pins 570 of the optical fibre connector ferrule 592 are positioned relative to the secondary microlenses 550 of the optical fibre connector ferrule 592 to ensure that the primary 2D curved TIR micromirrors 540 of the primary optical beam management element array component 590 and the secondary microlenses 550 of the optical fibre connector ferrule 592 are passively aligned when the pins 570 of the optical fibre connector ferrule 592 are inserted into the alignment holes 546 of the primary optical beam management element array component 590. The pins 570 may be formed integrally in the second monolithic block of fused silica 503b. Alternatively, the second monolithic block of fused silica 503b may define a plurality of holes, each hole configured to receive a corresponding one of the pins 570.

During assembly, the ledge 541a of the primary optical beam management element array component 590 is brought into engagement with the upper reference surface 569 of the photonic integrated circuit 504 for alignment of the plurality of primary 2D curved TIR micromirrors 540 of the primary optical beam management element array component 590 with the ends or optical ports 527 of the photonic integrated circuit 504 in the Z-direction.

Moreover, the one or more fiducial markers (not shown) of the primary optical beam management element array component 590 are aligned with the one or more corresponding fiducial markers (not shown) disposed on the upper reference surface 569 of the photonic integrated circuit 504 for alignment of the primary optical beam management element array component 590 and the photonic integrated circuit 504 in X and Y to thereby align each of the primary 2D curved TIR micromirrors 540 of the primary optical beam management element array component 590 with an end or optical port 527 of a corresponding one of the integrated optical waveguides 526 of the photonic integrated circuit 504 in the X and Y directions. The facet 541b of the primary optical beam management element array component 590 is then attached, for example bonded, to the facet 505b of the photonic integrated circuit 504.

Each optical fibre 506 of the plurality of optical fibres is attached, for example bonded, into a corresponding one of the optical fibre alignment holes 560 so that an end 507 of the corresponding optical fibre 506 is aligned with, but separated from, a corresponding one of the secondary microlenses 550.

The one or more pins 570 of the optical fibre connector ferrule 592 are then inserted into the one or more alignment holes 546 of the primary optical beam management element array component 590 and the surface 552 of the optical fibre connector ferrule 592 is brought into engagement with a surface 553 of the primary optical beam management element array component 590 so as to passively align the primary microlenses 540 of the primary optical beam management element array component 490 and the secondary microlenses 550 of the optical fibre connector ferrule 592.

It should be understood that adjacent primary 2D curved TIR micromirrors 540 are configured differently so as to direct light along non-parallel optical paths 564a, 564b, but that alternate primary 2D curved TIR micromirrors 540 are configured the same so as to direct light along parallel optical paths. Each optical path 564a extends in a plane parallel to the X-Z plane from the facet 541b of the primary optical beam management element array component 590 to an end 507a of one of the optical fibre alignment holes 560 via a corresponding one of the primary 2D curved TIR micromirrors 540, the first reflective surface 595a and a corresponding one of the secondary microlenses 550. In contrast, each optical path 564b extends from the facet 541b of the primary optical beam management element array component 590 to an end 507b of one of the optical fibre alignment holes 560 via a corresponding one of the primary 2D curved TIR micromirrors 540, the second reflective surface 595b and a corresponding one of the secondary microlenses 550, wherein the ends 507a, 507b of the optical fibre alignment holes 560 are aligned in a plane parallel to the X-Z plane. As may be appreciated from FIG. 6, each optical path 564a changes direction at the first reflective surface 595a of the first monolithic block of fused silica 503a and each optical path 564b changes direction at the second reflective surface 595b of the first monolithic block of fused silica 503a. Moreover, as a consequence of the configurations of the primary 2D curved TIR micromirrors 540, light may be coupled between the 1D array of integrated optical waveguide ends or ports 527 arranged along a direction parallel to the Y direction and the 2D array of optical fibres 506.

As may be appreciated from FIG. 6, the use of the primary 2D curved TIR micromirrors 540 and the secondary microlenses 550 serve to form a 2D array of expanded collimated optical beams which are transmitted horizontally between the primary optical beam management element array component 590 and the optical fibre connector ferrule 592 thereby relaxing the alignment tolerance required between the primary optical beam management element array component 590 and the optical fibre connector ferrule 592 for a given optical coupling efficiency.

Each of the primary 2D curved TIR micromirrors 540 may be defined independently of each of the other primary 2D curved TIR micromirrors 540. This may allow each of the primary 2D curved TIR micromirrors 540 to have a slightly different configuration, for example to be different in position (offset) relative to the corresponding optical path 564a, 564b or to have a different angle, curvature etc. Similarly, each of the secondary microlenses 550 may be defined independently of each of the other secondary microlenses 550. This may allow each of the secondary microlenses 550 to have a slightly different configuration, for example to be different in position (offset) relative to the corresponding optical path 564a, 564b or to have a different angle, curvature etc. Specifically, the configurations of the primary 2D curved TIR micromirrors 540 and the secondary microlenses 550 may be selected to form a 2D array of collimated beams between the primary optical beam management element array component 590 and the optical fibre connector ferrule 592 with the same or similar beam diameters and orientations.

From the foregoing description, it will be understood that the optical interconnect arrangement 502 may serve to optically couple the 1D array of integrated optical waveguides 526 of the photonic integrated circuit 504 and the 2D array of optical fibres 506 in a way that is simpler than prior art optical interconnect arrangements thereby enabling high density photonic integrated circuit optical I/O to be achieved more readily compared with prior art optical interconnect arrangements. Furthermore, as a result of the one or more pins 570 of the optical fibre connector ferrule 592 and the one or more alignment holes 546 of the primary optical beam management element array component 590, one of ordinary skill in the art will understand that the optical fibre connector ferrule 592 and the primary optical beam management element array component 590 are configured to be pluggable or connectable. The primary optical beam management element array component 590 and the optical fibre connector ferrule 592 may also include one or more mechanical features (not shown) such as one or more arms, clips or clamps for detachably attaching the primary optical beam management element array component 590 and the optical fibre connector ferrule 592, for example for connecting, latching or holding the primary optical beam management element array component 590 and the optical fibre connector ferrule 592 together.

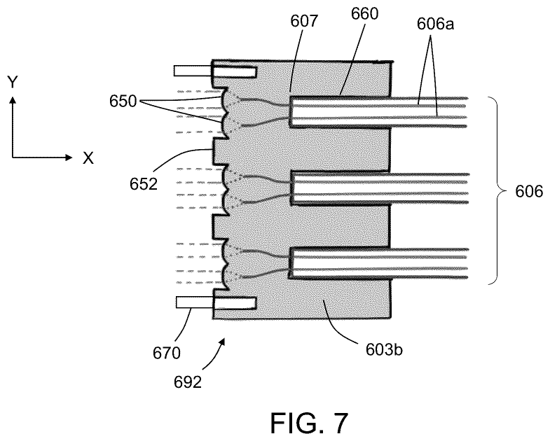

Referring now to FIG. 7 there is shown an optical fibre connector ferrule 692 for use in place of any of the optical fibre connector ferrules 292 392, 492, 592 and for use with a plurality of optical fibres 606, wherein each optical fibre 606 includes a plurality of optical fibre cores 606a. The optical fibre connector ferrule 692 includes a second monolithic block of material such as a second monolithic block of fused silica 603b and a plurality of secondary optical beam management elements in the form of a plurality of secondary microlenses 650 formed integrally on a surface 652 of the second monolithic block of fused silica 603b. The secondary microlenses 650 are arranged in a staggered arrangement or a uniform 2D array. The optical fibre connector ferrule 692 further includes a plurality of optical fibre alignment structures in the form of a plurality of fibre alignment holes 660 formed integrally in the second monolithic block of fused silica 603b, each fibre alignment hole 660 configured to receive an end section of a corresponding one of the optical fibres 606 so that each optical fibre core 606a at an end 607 of the corresponding optical fibre 606 is aligned with, but separated from, a corresponding one of the secondary microlenses 650.

The optical fibre connector ferrule 692 further includes alignment pins 670 for alignment of the optical fibre connector ferrule 692 with the alignment holes 246, 446, 546 of the primary optical beam management element array components 290, 490, 590 or with the alignment holes 398 of the reflector component 394. It should be understood that in other respects, the optical fibre connector ferrule 692 is similar to the optical fibre connector ferrules 292, 392, 492, 592. The alignment pins 670 may be formed integrally in the second monolithic block of fused silica 603b. Alternatively, the second monolithic block of fused silica 603b may define a plurality of holes, each hole configured to receive a corresponding one of the alignment pins 670.

It should be understood that formation of any of one or more of the plurality of primary optical beam management elements 40, 140, 240, 340, 440, 540, the reflective surfaces 295, 395, 495a, 495b, 595a, 595b, the plurality of secondary optical beam management elements 50, 150, 250, 350, 450, 550, 650, and the plurality of optical fibre alignment structures 60, 160, 260, 360, 460, 560, 660, may comprise using a laser such as an ultrafast laser or a femtosecond laser to inscribe a monolithic block of material in a plurality of regions so as to modify the material of the monolithic block in the plurality of regions. For example, formation of any of one or more of the plurality of primary optical beam management elements 40, 140, 240, 340, 440, 540, the reflective surfaces 295, 395, 495a, 495b, 595a, 595b, the plurality of secondary optical beam management elements 50, 150, 250, 350, 450, 550, 650, and the plurality of optical fibre alignment structures 60, 160, 260, 360, 460, 560, 660, may comprise using a laser such as an ultrafast laser or a femtosecond laser to inscribe a monolithic block of material in a plurality of regions so as to modify a refractive index of the material of the monolithic block in the plurality of regions. Formation of any of one or more of the plurality of primary optical beam management elements 40, 140, 240, 340, 440, 540, the reflective surfaces 295, 395, 495a, 495b, 595a, 595b, the plurality of secondary optical beam management elements 50, 150, 250, 350, 450, 550, 650, and the plurality of optical fibre alignment structures 60, 160, 260, 360, 460, 560, 660, may comprise using the laser to inscribe the monolithic block of material in the plurality of regions so as to modify a chemical etchability of the material of the monolithic block in the plurality of regions and subsequently removing the modified material of the monolithic block from the plurality of regions, for example by chemical etching. Formation of any of one or more of the plurality of primary optical beam management elements 40, 140, 240, 340, 440, 540, the reflective surfaces 295, 395, 495a, 495b, 595a, 595b, the plurality of secondary optical beam management elements 50, 150, 250, 350, 450, 550, 650, and the plurality of optical fibre alignment structures 60, 160, 260, 360, 460, 560, 660, may comprise using the laser to inscribe the monolithic block of material in the plurality of regions so as to ablate the material of the monolithic block in the plurality of regions. Moreover, the monolithic block of material may comprise a monolithic block of glass such as a monolithic block of fused silica.

One of ordinary skill in the art will understand that various modifications may be made to the embodiments of the present disclosure described above without departing from the scope of the present invention as defined according to the appended claims. For example, although the optical fibre connector ferrule 192 of FIG. 2 comprises a plurality of 2D curved TIR micromirrors 150, in an alternative embodiment of the optical fibre connector ferrule 192 of FIG. 2, the curved TIR micromirrors 150 may be replaced by 2D curved micromirrors formed on the underside 153 of the monolithic block of fused silica 103b.

Although each of the photonic integrated circuits 4, 104, 204, 304, 404 is described above as comprising a plurality of grating coupler elements 27, 127, 227, 327, 427 for coupling light to/from a plurality of integrated optical waveguides of the photonic integrated circuits 4, 104, 204, 304, 404 through the upper surfaces 69, 169, 269, 369, 469 of the photonic integrated circuits 4, 104, 204, 304, surface coupler elements of other kinds may be used to couple light to/from the plurality of integrated optical waveguide of the photonic integrated circuits 4, 104, 204, 304, 404 through the upper surfaces 69, 169, 269, 369, 469 of the photonic integrated circuits 4, 104, 204, 304, 404. For example, 2D curved micromirrors, such as 2D TIR curved micromirrors, may be used to couple light to/from the plurality of integrated optical waveguide of the photonic integrated circuits 4, 104, 204, 304, 404 through the upper surfaces 69, 169, 269, 369, 469 of the photonic integrated circuits 4, 104, 204, 304, 404.

Although the plurality of primary optical beam management elements 40, 140, 240, 340, the plurality of secondary optical beam management elements 50, 150, 250, 350, 650, and the plurality of optical fibre alignment structures 60, 160, 260, 360, 660 are all described above as being arranged in a staggered arrangement or a 2D array, the plurality of primary optical beam management elements 40, 140, 240, 340, the plurality of secondary optical beam management elements 50, 150, 250, 350, 650, and the plurality of optical fibre alignment structures 60, 160, 260, 360, 660 may be arranged in a uniform 1D array wherein the pitch of the primary optical beam management elements 40, 140, 240, 340 is smaller than a pitch of the secondary optical beam management elements 50, 150, 250, 350, 650, and a pitch of the plurality of optical fibre alignment structures 60, 160, 260, 360, 660. For example, in the embodiment of FIG. 3, the slope of the reflective surface 295 and the orientation of the surface 253 of the primary optical beam management element array component 290 may be selected accordingly. Similarly, in the embodiment of FIG. 4, the slope of the reflective surface 395 and the orientation of the surface 353 of the reflector component 394 may be selected accordingly.

Although the grating couplers 227 and the primary microlenses 240 in the embodiment of FIG. 3 are configured so that the optical paths 264 are aligned at an acute angle relative to a vertical direction between the corresponding grating coupler 227 and the reflective surface 295 and so that the optical paths 264 change direction by approximately 120° at the reflective surface 295, in a variant of the embodiment of FIG. 3, the grating couplers 227 and the primary microlenses 240 may be configured so that the optical paths 264 are aligned in a vertical or near-vertical direction between the corresponding grating coupler 227 and the reflective surface 295 and may change direction by an angle in the region of 90° at the reflective surface 295.

Although the grating couplers 27, 127 and the primary microlenses 40, 140 in the embodiments of FIGS. 1A and 1B, and FIG. 2 are configured so that the optical paths 64 and 164 are aligned in a vertical direction between the grating couplers 27, 127 and the 2D curved TIR micromirrors 50, 150 and so that the optical paths 64, 164 change direction by approximately 90° at the 2D curved TIR micromirrors 50, 150, in a variant of the embodiments of FIGS. 1A and 1B, and FIG. 2, the grating couplers 27, 127 and the primary microlenses 40, 140 may be configured so that the optical paths 64, 164 are aligned at an acute angle relative to the vertical direction between the corresponding grating coupler 27, 127 and the 2D curved TIR micromirrors 50, 150 and may change direction by an angle of greater than 90° at the 2D curved TIR micromirrors 50, 150. Similarly, although the grating couplers 327 and the primary microlenses 340 in the embodiment of FIG. 4 are configured so that the optical paths 364 are aligned in a vertical direction between the grating couplers 327 and the reflective surface 395 and so that the optical paths 364 change direction by approximately 90° at the reflective surface 395, in a variant of the embodiments of FIG. 3, the grating couplers 327 and the primary microlenses 340 may be configured so that the optical paths 364 are aligned at an acute angle relative to the vertical direction between the corresponding grating coupler 327 and the reflective surface 395 and may change direction by an angle of greater than 90° at the reflective surface 395.

Instead of the plurality of optical ports 527 of the photonic integrated circuit 504 of FIG. 6 being separated from an upper reference surface 569 of the photonic integrated circuit 504 by a predetermined distance, the plurality of optical ports 527 of the photonic integrated circuit 504 may be separated from the ledge 505a of the photonic integrated circuit 504 by a predetermined distance. Moreover, instead of the plurality of primary 2D curved TIR micromirrors 540 and the ledge 542a of the primary optical beam management element array component 590 being separated in the Z-direction by a predetermined distance which matches the predetermined distance by which the plurality of optical ports 527 of the photonic integrated circuit 504 and the upper reference surface 569 of the photonic integrated circuit 504 are separated in the Z-direction, the plurality of primary 2D curved TIR micromirrors 540 and a lower reference surface of the primary optical beam management element array component 590 may be separated in the Z-direction by a predetermined distance which matches the predetermined distance by which the plurality of optical ports 527 of the photonic integrated circuit 504 and the ledge 505a of the photonic integrated circuit 504 are separated in the Z-direction. Furthermore, the step of the primary optical beam management element array component 590 may be configured to allow engagement between the ledge 505a of the photonic integrated circuit 504 and the lower reference surface of the primary optical beam management element array component 590 without the ledge 542a of the primary optical beam management element array component 590 engaging the photonic integrated circuit 504. Consequently, engagement between the ledge 505a of the photonic integrated circuit 504 and the lower reference surface of the primary optical beam management element array component 590 results in alignment of the plurality of primary 2D curved TIR micromirrors 540 of the primary optical beam management element array component 590 with the ends or optical ports 527 of the photonic integrated circuit 504 in the Z-direction.

Each feature disclosed or illustrated in the present specification may be incorporated in any embodiment, either alone, or in any appropriate combination with any other feature disclosed or illustrated herein. In particular, one of ordinary skill in the art will understand that one or more of the features of the embodiments of the present disclosure described above with reference to the drawings may produce effects or provide advantages when used in isolation from one or more of the other features of the embodiments of the present disclosure and that different combinations of the features are possible other than the specific combinations of the features of the embodiments of the present disclosure described above.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Use of the term “comprising” when used in relation to a feature of an embodiment of the present disclosure does not exclude other features or steps. Use of the term “a” or “an” when used in relation to a feature of an embodiment of the present disclosure does not exclude the possibility that the embodiment may include a plurality of such features.

The use of any reference signs in the claims should not be construed as limiting the scope of the claims.

1-25. (canceled)

26. An optical interconnect arrangement comprising:
a plurality of primary optical beam management elements, individual of the plurality of primary optical beam management elements to collimate light received from a corresponding optical element of a plurality of optical elements of a photonic integrated circuit or to focus light onto the corresponding optical element of the photonic integrated circuit;
a plurality of secondary optical beam management elements, individual of the plurality of secondary optical beam management elements to focus light onto an end of a corresponding one of a plurality of optical fibres or to collimate light received from the end of the corresponding one of the plurality of optical fibres; and
a plurality of optical fibre alignment structures, wherein individual of the plurality of optical fibre alignment structures are configured to receive a corresponding optical fibre so that the end of the corresponding optical fibre is aligned with, but separated from, a corresponding one of the plurality of secondary optical beam management elements, and wherein the optical interconnect arrangement defines a plurality of optical paths, individual of the plurality of optical paths extending from a surface of the optical interconnect arrangement to the end of a corresponding one of the plurality of optical fibre alignment structures via a corresponding one of the plurality of primary optical beam management elements and a corresponding one of the plurality of secondary optical beam management elements.

27. The optical interconnect arrangement of claim 26, further comprising a photonic integrated circuit comprising a plurality of integrated optical waveguides and individual of the plurality of optical elements of the photonic integrated circuit comprising a surface coupler element of a plurality of surface coupler elements for directing light into or out of a corresponding one of the plurality of integrated optical waveguides through a surface of the photonic integrated circuit, wherein individual of the plurality of primary optical beam management elements is to focus light onto a corresponding one of the plurality of surface coupler elements or to collimate light received from the corresponding one of the plurality of surface coupler elements.

28. The optical interconnect arrangement of claim 26, further comprising a photonic integrated circuit comprising a plurality of integrated optical waveguides, wherein the photonic integrated circuit comprises a step at an edge of the photonic integrated circuit, the step comprises a ledge and a facet, individual of the plurality of integrated optical waveguides ends at the facet of the photonic integrated circuit so as to define a corresponding optical port at the facet, the plurality of integrated optical waveguides defining a plurality of optical ports, individual of the plurality of optical elements comprising a corresponding one of the plurality of optical ports, and wherein the optical interconnect arrangement comprises a step at an edge of the optical interconnect arrangement, wherein the step comprises a ledge and a facet, wherein the facet of the optical interconnect arrangement is to be disposed between the plurality of optical ports of the photonic integrated circuit and the plurality of primary optical beam management elements, and wherein individual of the plurality of primary optical beam management elements is to focus light onto a corresponding one of the plurality of optical ports or to collimate light received from the corresponding one of the plurality of optical ports.

29. The optical interconnect arrangement of claim 28, wherein the plurality of primary optical beam management elements and the ledge are separated by a first distance in a dimension that matches a second distance by which the plurality of optical ports of the photonic integrated circuit and a surface of the photonic integrated circuit are separated in the dimension, and wherein the step of the optical interconnect arrangement is to allow engagement between the ledge of the optical interconnect arrangement and the surface of the photonic integrated circuit without the ledge of the photonic integrated circuit engaging the optical interconnect arrangement.

30. The optical interconnect arrangement of claim 28, wherein the plurality of primary optical beam management elements of the optical interconnect arrangement and a reference surface of the optical interconnect arrangement are separated by a predetermined distance in a dimension which matches a predetermined distance by which the plurality of optical ports of the photonic integrated circuit and the ledge of the photonic integrated circuit are separated in the dimension, and wherein the step of the optical interconnect arrangement is configured to allow engagement between the reference surface of the optical interconnect arrangement and the ledge of the photonic integrated circuit without the ledge of the optical interconnect arrangement engaging the photonic integrated circuit.

31. The optical interconnect arrangement of claim 26, wherein the optical interconnect arrangement comprises an optical interconnect component which comprises a monolithic block of material, the monolithic block of material comprising the plurality of primary optical beam management elements, the plurality of secondary optical beam management elements, and the plurality of optical fibre alignment structures.

32. The optical interconnect arrangement of claim 26, wherein one or more of the plurality of primary optical beam management elements or one or more of the plurality of secondary optical beam management elements comprises:
a microlens;
a graded index (GRIN) lens;
a waveguide; or
a 2D curved micromirror.

33. The optical interconnect arrangement of claim 26, wherein two or more of the plurality of primary optical beam management elements are arranged in a plane and a corresponding two or more of the plurality of optical fibre alignment structures are arranged in the plane.

34. The optical interconnect arrangement of claim 26, wherein adjacent primary optical beam management elements are to direct light along parallel optical paths.

35. The optical interconnect arrangement of claim 26, wherein adjacent primary optical beam management elements are to direct light along non-parallel optical paths and alternate primary optical beam management elements are to direct light along parallel optical paths.

36. The optical interconnect arrangement of claim 26, wherein two or more of the plurality of primary optical beam management elements and a corresponding two or more optical fibre alignment structures are arranged in different planes.

37. The optical interconnect arrangement of claim 26, comprising:
a primary optical beam management element array component, wherein the primary optical beam management element array component comprises a first monolithic block of material, the first monolithic block of material comprising the plurality of primary optical beam management elements; and
an optical fibre connector ferrule, wherein the optical fibre connector ferrule comprises a second monolithic block of material, the second monolithic block of material comprising the plurality of secondary optical beam management elements and the plurality of optical fibre alignment structures.

38. The optical interconnect arrangement of claim 26, comprising:
a reflective primary optical beam management element array component, wherein the reflective primary optical beam management element array component comprises a first monolithic block of material, the first monolithic block of material defining the plurality of primary optical beam management elements and a reflector, wherein individual of the plurality of optical paths changes direction at the reflector; and
an optical fibre connector ferrule, wherein the optical fibre connector ferrule comprises a second monolithic block of material, the second monolithic block of material comprising the plurality of secondary optical beam management elements and the plurality of optical fibre alignment structures.

39. The optical interconnect arrangement of claim 38, wherein the reflective primary optical beam management element array component comprises one or more alignment features, the first monolithic block of material comprising the one or more alignment features of the reflective primary optical beam management element array component and individual of the one or more alignment features to engage a corresponding complementary alignment feature of the photonic integrated circuit for passive alignment of the reflective primary optical beam management element array component and the photonic integrated circuit.

40. The optical interconnect arrangement of claim 38, wherein the reflective primary optical beam management element array component and the optical fibre connector ferrule comprise one or more complementary inter-engaging alignment features for passive alignment of the reflective primary optical beam management element array component and the optical fibre connector ferrule.

41. The optical interconnect arrangement of claim 26, comprising:
a primary optical beam management element array component, wherein the primary optical beam management element array component comprises a first monolithic block of material, the first monolithic block of material comprising the plurality of primary optical beam management elements;
a reflector component defining a reflector, wherein individual of the plurality of optical paths changes direction at the reflector, wherein the reflector component comprises a third monolithic block of material, the third monolithic block of material comprising the reflector; and
an optical fibre connector ferrule, wherein the optical fibre connector ferrule comprises a second monolithic block of material, the second monolithic block of material comprising the plurality of secondary optical beam management elements and the plurality of optical fibre alignment structures.

42. The optical interconnect arrangement of claim 41, wherein the primary optical beam management element array component and the reflector component comprise one or more complementary inter-engaging alignment features for passive alignment of the primary optical beam management element array component and the reflector component.

43. The optical interconnect arrangement of claim 41, further comprising a secondary optical beam management element array component wherein the secondary optical beam management element array component and the reflector component comprise one or more complementary inter-engaging alignment features for passive alignment of the secondary optical beam management element array component and the reflector component.

44. An optical system comprising the optical interconnect arrangement of claim 26, a photonic integrated circuit, and a plurality of optical fibres, wherein the photonic integrated circuit is attached to the optical interconnect arrangement, and wherein individual of the plurality of optical fibres is attached to a corresponding optical fibre alignment structure of the optical interconnect arrangement.

45. The optical system of claim 44, wherein individual of the plurality of optical fibres comprises a plurality of optical fibre cores and wherein individual of the plurality of optical fibre alignment structures is to engage a corresponding optical fibre so that an end of individual of the plurality of optical fibre cores of the corresponding optical fibre is aligned with, but separated from, a corresponding one of the plurality of secondary optical beam management elements.
